(19) United States
(12) Patent Application Publication
(10) Pub. No.: US 2007/0206283 A1
(43) Pub. Date: Sep. 6, 2007

(54) Production Method of Antireflection Film, Antireflection Film, Polarizing Plate and Image Display Device

(75) Inventors: Shigeaki Ohtani, Fujinomiya-shi (JP); Yuichi Fukushige, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: Fuji Photo Film Co., Ltd., Minami-Ashigara-shi (JP)

(21) Appl. No.: 10/592,518

(22) PCT Filed: Mar. 23, 2005
(86) PCT No.: PCT/JP05/05202

§ 371 Date: Sep. 12, 2006

(30) Foreign Application Priority Data
Mar. 26, 2004 (JP) 2004-093249

(51) Int. Cl. G02B 1/11; B29C 71/00; G02B 5/30

(52) U.S. Cl. 359/493; 264/345; 359/586

(57) ABSTRACT

To provide a production method of an antireflection film excellent in the scratch resistance while having sufficiently high antireflection performance; an antireflection film obtained by the production method; and a polarizing plate and an image display device each comprising the antireflection film. A method for producing an antireflection film comprising a transparent substrate having thereon an antireflection layer comprising at least one layer, the production method comprising forming at least one layer on the transparent support by a layer forming method comprising the following steps (1) and (2): (1) a step of applying a coating layer on a transparent substrate, and (2) a step of curing the coating layer by irradiating ionizing radiation in an atmosphere having an oxygen concentration lower than the oxygen concentration in the air.

### TECHNICAL FIELD

The present invention relates to a production method of an antireflection film having low reflectance and excellent scratch resistance, and an antireflection film obtained by the production method. Furthermore, the present invention relates to a polarizing plate and an image display device each comprising the antireflection film.

### BACKGROUND ART

In a display device such as cathode ray tube display device (CRT), plasma display panel (PDP), electroluminescent display (ELD) and liquid crystal display device (LCD), an antireflection film is disposed on the outermost surface of the display so as to reduce the reflectance by utilizing the principle of optical interference and thereby prevent the reduction in contrast due to reflection of outside light or the projection of an image.

Such an antireflection film can be produced by forming a low refractive index layer having a proper thickness on the outermost surface of a support (substrate) and depending on the case, appropriately forming a high refractive index layer, a medium refractive index layer and a hardcoat layer between the low refractive index layer and the support. In order to realize a low reflectance, a material having a refractive index as low as possible is preferably used for the low refractive index layer. Furthermore, since the antireflection film is used on the outermost surface of a display, this film is required to have high scratch resistance. In order to realize high scratch resistance of a thin film having a thickness of about 100 nm, strength of the film itself and tight adhesion to the underlying layer are necessary.

The means for reducing the refractive index of a material includes introduction of a fluorine atom and reduction in the density (introduction of voids), but either means tends to impair the film strength and adhesion and decrease the scratch resistance. Thus, it has been difficult to achieve both low refractive index and high scratch resistance.

Patent Documents 1 to 3 describe a technique of introducing a polysiloxane structure into a fluorine-containing polymer, thereby decreasing the coefficient of friction on the film surface and improving the scratch resistance. This means is effective to a certain extent for the improvement of scratch resistance, but in the case of a film substantially lacking in the film strength and interface adhesion, sufficiently high scratch resistance cannot be obtained only by this means.

On the other hand, Patent Document 4 describes a technique of curing a photocurable resin in an atmosphere having a low oxygen concentration, whereby the hardness is increased. However, in order to efficiently produce an antireflection film in the web form, the concentration allowing for displacement with nitrogen is limited and a sufficiently high hardness cannot be obtained.

Patent Documents 5 to 10 specifically describe the means for the nitrogen displacement, but in order to reduce the oxygen concentration to the extent of enabling sufficient cure of a thin film such as low refractive index layer, a large amount of nitrogen is necessary and this causes a problem that the production cost increases.

Also, Patent Document 11 describes a method of winding the film around the surface of a heat roll and irradiating ionizing radiation thereon, but this is still insufficient for satisfactorily curing a special thin film such as low refractive index layer.

| | |
|---|---|
| Patent Document 1: | JP-A-11-189621 |
| Patent Document 2: | JP-A-11-228631 |
| Patent Document 3: | JP-A-2000-313709 |
| Patent Document 4: | JP-A-2002-156508 |
| Patent Document 5: | JP-A-11-268240 |
| Patent Document 6: | JP-A-60-90762 |
| Patent Document 7: | JP-A-59-112870 |
| Patent Document 8: | JP-A-4-301456 |
| Patent Document 9: | JP-A-3-67697 |
| Patent Document 10: | JP-A-2003-300215 |
| Patent Document 11: | JP-B-7-51641 |

### DISCLOSURE OF THE INVENTION PROBLEMS TO BE SOLVED BY THE INVENTION

An object of the present invention is to provide a production method of an antireflection film enhanced in the scratch resistance while having sufficiently high anti-reflection performance, and an antireflection film obtained by this method. Another object of the present invention is to provide a polarizing plate and an image display device each comprising such an antireflection film.

### MEANS TO SOLVE THE PROBLEMS

As a result of intensive investigations, the present inventors have found that the above-described objects can be attained by the production method of an antireflection film, the antireflection film obtained by this method, the polarizing plate and the image display device, which are described below.

[1] A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) and (2):

(1) a step of applying a coating layer on a transparent substrate, and

(2) a step of curing said coating layer by irradiating ionizing radiation in an atmosphere having an oxygen concentration lower than the oxygen concentration in the air.

[2] A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) to (3), with the transportation step of (2) and the curing step of (3) being continuously performed:

(1) a step of applying a coating layer on a transparent substrate,

(2) a step of transporting said film having the coating layer in an atmosphere having an oxygen concentration lower than the oxygen concentration in the air, and

(3) a step of curing the coating layer by irradiating ionizing radiation on said film in an atmosphere having an oxygen concentration of 3 vol % or less.

[3] A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) to (3), with the transportation step of (2) and the curing step of (3) being continuously performed:

(1) a step of applying a coating layer on a transparent substrate,

(2) a step of transporting said film having the coating layer in an atmosphere having an oxygen concentration lower than the oxygen concentration in the air, and

(3) a step of curing the coating layer by irradiating ionizing radiation on said film in an atmosphere having an oxygen concentration of 3 vol % or less while heating the film to give a film surface temperature of 25° C. or more.

[4] A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) to (3), with the transportation step of (2) and the curing step of (3) being continuously performed:

(1) a step of applying a coating layer on a transparent substrate,

(2) a step of transporting said film having the coating layer in an atmosphere having an oxygen concentration lower than the oxygen concentration in the air while heating the film to give a film surface temperature of 25° C. or more, and

(3) a step of curing the coating layer by irradiating ionizing radiation on said film in an atmosphere having an oxygen concentration of 3 vol % or less.

[5] A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) to (3), with the transportation step of (2) and the curing step of (3) being continuously performed:

(1) a step of applying a coating layer on a transparent substrate,

(2) a step of transporting said film having the coating layer in an atmosphere having an oxygen concentration lower than the oxygen concentration in the air while heating the film to give a film surface temperature of 25° C. or more, and

(3) a step of curing the coating layer by irradiating ionizing radiation on said film in an atmosphere having an oxygen concentration of 3 vol % or less while heating the film to give a film surface temperature of 25° C. or more.

[6] The method for producing an antireflection film comprising: a transparent substrate; an antireflection layer comprising at least one layer, the antireflection layer on the transparent substrate,

wherein the layer forming method described in any one of [1] to [5] above, comprises, in succession to the curing step of the coating layer by the irradiation with ionizing radiation, a step of transporting the cured film in an atmosphere having an oxygen concentration of 3 vol % or less while heating the film to give a film surface temperature of 25° C. or more.

[7] The method for producing an antireflection film, wherein said antireflection film comprises a low refractive index layer having a thickness of 200 nm or less and said low refractive index layer is formed by the layer forming method as claimed in any one of [1] to [6] above.

[8] The method for producing an antireflection film as described in any one of [1] to [7] above,

wherein the ionizing radiation is an ultraviolet ray.

[9] The method for producing an antireflection film as described in any one of [3] to [8] above,

wherein the heating during and/or before the irradiation with ionizing radiation and/or the heating after the irradiation with ionizing radiation is performed to give a film surface temperature of 25 to 170° C.

[10] The method for producing an antireflection film as described in any one of [3] to [9] above,

wherein the heating during and/or before the irradiation with ionizing radiation and/or the heating after the irradiation with ionizing radiation is performed by contacting the film with a heated roll.

[11] The method for producing an antireflection film as described in any one of [3] to [9] above,

wherein the heating during and/or before the irradiation with ionizing radiation and/or the heating after the irradiation with ionizing radiation is performed by blowing a heated nitrogen gas.

[12] The method for producing an antireflection film as described in any one of [1] to [11] above,

wherein the transportation step and/or the curing step by the irradiation with ionizing radiation each is performed in a low oxygen concentration zone displaced with nitrogen, and the nitrogen in the zone for performing the curing step by the irradiation with ionizing radiation is discharged to the zone for performing the previous step and/or the zone for performing the subsequent step.

[13] An antireflection film produced by the method described in any one of [1] to [12] above.

[14] The antireflection film as described in [13] above,

wherein the low refractive index layer is formed by a coating solution comprising a fluorine-containing polymer represented by the following formula 1:
Formula 1: 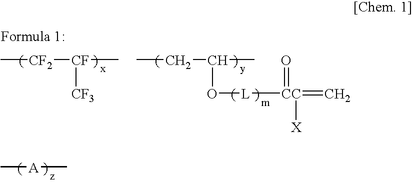
wherein L represents a linking group having a carbon number of 1 to 10, m represents 0 or 1, X represents a hydrogen atom or a methyl group, A represents a polymerization unit of an arbitrary monomer and may comprise a single component or a plurality of components, and x, y and z represent mol% of respective constituent components and each represents a value satisfying 30≦x≦60, 5≦y≦70 and 0≦z≦65.

[15] The antireflection film as described in [13] or [14] above,

wherein the low refractive index layer comprises a hollow silica fine particle.

[16] A polarizing plate comprising the antireflection film described in any one of

[13] to [15] above as at least either one protective film of two protective films in the polarizing plate.

[17] An image display device comprising the antireflection film described in any one of [13] to [15] above or the polarizing plate described in [16] above on the outermost surface of the display.

### EFFECTS OF THE INVENTION

According to the production method of an antireflection film of the present invention, antireflection film enhanced in the scratch resistance while having sufficiently high antireflection performance can be provided.

The image display device comprising the antireflection film or polarizing plate produced by the present invention is reduced in the reflection of outside light or the projection of surrounding scenes and assured of very high visibility and excellent scratch resistance.

### BRIEF DESCRIPTION OF THE DRAWINGS

FIG. 1 A cross-sectional view schematically showing one example of the antireflection film having an antiglare property.

FIG. 2 A schematic view showing one example of the construction of an apparatus for producing the antireflection film of the present invention.

### DESCRIPTION OF NUMERICAL REFERENCES

1 Antiglare antireflection film
2 Transparent support
3 Antiglare layer
4 Low refractive index layer
5 Light-transparent fine particle
W Web
10 Substrate film roll
20 Take-up roll
100, 200, 300, 400 Film-forming unit
101, 201, 301, 401 Coating section
102, 202, 302, 402 Drying section
103, 203, 303, 403 Curing device

### BEST MODE FOR CARRYING OUT THE INVENTION

The present invention is described in detail below. Incidentally, the term “from (numerical value 1) to (numerical value 2)” as used in the present invention for expressing a physical value, a characteristic value or the like means “(numerical value 1) or more and (numerical value 2) or less”.

[Layer Construction of Antireflection Film]

The antireflection film of the present invention has, if desired, a hardcoat layer described later on a transparent substrate (hereinafter sometimes referred to as a “substrate film”) and has an antireflection layer stacked thereon by taking account of the refractive index, film thickness, number of layers and order of layers so as to reduce the reflectance by the effect of optical interference. In a simplest layer construction of the antireflection film, only a low refractive index layer is provided by coating on a substrate. In order to more reduce the reflectance, the antireflection layer is preferably constituted by combining a high refractive index layer having a refractive index higher than that of the substrate and a low refractive index layer having a refractive index lower than that of the substrate. Examples of the construction include a two-layer construction of high refractive index layer/low refractive index layer from the substrate side, and a construction formed by stacking three layers differing in the refractive index in the order of middle refractive index layer (layer having a refractive index higher than that of the substrate or hardcoat layer but lower than that of high refractive index layer)/high refractive index layer/low refractive index layer. Also, a layer construction where a larger number of antireflection layers are stacked has been proposed. In view of the durability, optical properties, cost, productivity and the like, a construction where a middle refractive index layer/a high refractive index layer/a low refractive index layer are stacked in this order on a substrate having thereon a hardcoat layer, is preferred. It is also preferred that the antireflection film of the present invention has a functional layer such as antiglare layer and antistatic layer.

Preferred construction examples of the antireflection film of the present invention include the followings:

substrate film/low refractive index layer,

substrate film/antiglare layer/low refractive index layer,

substrate film/hardcoat layer/antiglare layer/low refractive index layer,

substrate film/hardcoat layer/high refractive index layer/low refractive index layer,

substrate film/hardcoat layer/medium refractive index layer/high refractive index layer/low refractive index layer,

substrate film/antiglare layer/high refractive index layer/low refractive index layer,

substrate film/antiglare layer/medium refractive index layer/high refractive index layer/low refractive index layer,

substrate film/antistatic layer/hardcoat layer/medium refractive index layer/high refractive index layer/low refractive index layer,

antistatic layer/substrate film/hardcoat layer/medium refractive index layer/high refractive index layer/low refractive index layer,

substrate film/antistatic layer/antiglare layer/ medium refractive index layer/high refractive index layer/low refractive index layer,

antistatic layer/substrate film/antiglare layer/ medium refractive index layer/high refractive index layer/low refractive index layer, and

antistatic layer/substrate film/antiglare layer/high refractive index layer/low refractive index layer/high refractive index layer/low refractive index layer.

Insofar as the reflectance can be reduced by the optical interference, the antireflection film of the present invention is not particularly limited only to these layer constructions. The high refractive index layer may be a light-diffusing layer not having an antiglare property. The antistatic layer is preferably a layer containing an electrically conducting polymer particle or a metal oxide fine particle (e.g., SnO₂, ITO) and may be provided by coating, atmospheric plasma treatment or the like.

[Film Formation Method]

The production method of an antireflection film of the present invention is characterized by forming at least one layer out of the layers stacked on a transparent substrate of the antireflection film, by the following layer forming method.

The first to fifth layer forming methods according to the present invention are described in detail below.

(First Layer Forming Method)

A layer forming method comprising the following steps (1) and (2):

(1) a step of applying a coating layer on a transparent substrate, and

(2) a step of curing the coating layer by irradiating ionizing radiation in an atmosphere having an oxygen concentration lower than the oxygen concentration in the air.

(Second Layer Forming Method)

A layer forming method comprising the following steps (1) to (3), with the transportation step of (2) and the curing step of (3) being continuously performed:

(1) a step of applying a coating layer on a transparent substrate,

(2) a step of transporting the film having the coating layer in an atmosphere having an oxygen concentration lower than the oxygen concentration in the air, and

(3) a step of curing the coating layer by irradiating ionizing radiation on the film in an atmosphere having an oxygen concentration of 3 vol % or less.

(Third Layer Forming Method)

A layer forming method comprising the following steps (1) to (3), with the transportation step of (2) and the curing step of (3) being continuously performed:

(1) a step of applying a coating layer on a transparent substrate,

(2) a step of transporting the film having the coating layer in an atmosphere having an oxygen concentration lower than the oxygen concentration in the air, and

(3) a step of curing the coating layer by irradiating ionizing radiation on the film in an atmosphere having an oxygen concentration of 3 vol % or less while heating the film to give a film surface temperature of 25° C. or more.

(Fourth Layer Forming Method)

A layer forming method comprising the following steps (1) to (3), with the transportation step of (2) and the curing step of (3) being continuously performed:

(1) a step of applying a coating layer on a transparent substrate,

(2) a step of transporting the film having the coating layer in an atmosphere having an oxygen concentration lower than the oxygen concentration in the air while heating the film to give a film surface temperature of 25° C. or more, and

(3) a step of curing the coating layer by irradiating ionizing radiation on the film in an atmosphere having an oxygen concentration of 3 vol % or less.

(Fifth Layer Forming Method)

A layer forming method comprising the following steps (1) to (3), with the transportation step of (2) and the curing step of (3) being continuously performed:

(1) a step of applying a coating layer on a transparent substrate,

(2) a step of transporting the film having the coating layer in an atmosphere having an oxygen concentration lower than the oxygen concentration in the air while heating the film to give a film surface temperature of 25° C. or more, and

(3) a step of curing the coating layer by irradiating ionizing radiation on the film in an atmosphere having an oxygen concentration of 3 vol % or less while heating the film to give a film surface temperature of 25° C. or more.

In particular, the low refractive index layer as the outermost layer is preferably formed by these methods.

The first to fifth layer forming methods are collectively described below.

The coating layer on the transparent layer is formed by applying a coating composition (coating solution) of the layer to be formed on the transparent substrate and drying the composition. The method of applying a coating solution is not particularly limited. Also, the transparent substrate for use in the present invention may have either a cutout form or a web form, but in view of the production cost, a web form is preferred.

In view of the film hardness, the step of irradiating ionizing radiation is performed in an environment where the oxygen concentration is lower than the atmospheric oxygen concentration, preferably in an atmosphere having an oxygen concentration of 3 vol % or less, more preferably 1 vol % or less, still more preferably 0.1 vol % or less.

At the step of irradiating ionizing radiation, the oxygen concentration needs to be lower than the oxygen concentration in the air.

In the second to fifth layer forming methods, a curing step by the irradiation with ionizing radiation is performed in succession to the transportation step. Immediately before the step of irradiating ionizing radiation on the film after the providing (coating and drying) of a coating layer, the film is transported in an atmosphere having an oxygen concentration lower than the atmospheric oxygen concentration (hereinafter sometimes referred to as a “low oxygen concentration zone before irradiation”), whereby the oxygen concentration on the surface and in the inside of the coating film can be effectively reduced and the curing can be accelerated.

Incidentally, the embodiment of performing the curing step in succession to the transportation step is an embodiment where the film to be transported into a low oxygen concentration atmosphere of performing the curing step (hereinafter sometimes referred to as an “ionizing radiation irradiation zone”) is passed through a zone having an oxygen concentration lower than the atmospheric oxygen concentration immediately before entering the ionizing radiation irradiation zone. For example, an embodiment of sequentially performing the transportation step and the curing step in the same chamber kept to a low oxygen concentration may be considered.

In the second to fifth layer forming methods, this embodiment may suffice if it comprises steps of passing the film having a coating layer on a transparent substrate through the low oxygen concentration zone before irradiation and successively irradiating ionizing radiation, and the film forming method may comprise a drying step or a heating step in the low oxygen concentration zone before irradiation.

The upper limit of the oxygen concentration in the transportation step before the irradiation with ionizing radiation may be sufficient if it is less than the oxygen concentration in the air, and the upper limit is preferably 15 vol % or less, more preferably 10 vol % or less, and most preferably 5 vol % or less.

As for the lower limit of the oxygen concentration in the transportation step before the irradiation with ionizing radiation, in view of the cost, this may be sufficient if it is an oxygen concentration not lower than that in the step of irradiating ionizing radiation.

The third to fifth layer forming methods each is characterized in that at the ionizing radiation irradiation step and/or the transportation step before irradiation with ionizing radiation, heating is performed to cause the film surface to reach 25° C. or more. The heating is preferably performed to cause the film surface to reach 25 to 170° C., more preferably from 60 to 170° C., still more preferably from 80 to 130° C. By virtue of heating at the transportation step before irradiation with ionizing radiation, smooth heating at the irradiation with ionizing radiation can be accelerated, and by virtue of heating at the irradiation with ionizing radiation, the curing reaction initiated by the effect of ionizing radiation can be accelerated due to heat and a film excellent in the physical strength and chemical resistance can be formed. When the film surface is heated to 25° C. or more, this makes it easy to obtain the effect of heating, and when heated to 170° C. or less, generation of a problem such as deformation of substrate can be avoided. Incidentally, the film surface indicates the vicinity of the film surface of the layer to be cured.

The time for which the film surface is kept at the above-described temperature is preferably 0.1 second or more after the initiation of irradiation with ionizing radiation, and preferably 300 seconds or less, more preferably 10 seconds or less. If the time for which the film surface temperature is kept in the above-described temperature range is too short, the reaction of the curable composition for forming a film cannot be accelerated, whereas if it is excessively long, the optical performance of the film is deteriorated and there arises a problem in view of the production, such as increase in the equipment size.

The heating method is not particularly limited but, for example, a method of heating a roll and contacting the film with the roll, a method of blowing heated nitrogen, and a method of irradiating a far infrared ray or an infrared ray are preferred. The heating method of flowing warm water or steam to a rotating metal roll, described in Japanese Patent 2,523,574, may also be used.

The first to fifth layer forming methods each may further comprise, in succession to the curing step by the irradiation with ionizing radiation, a step of transporting the cured film in an atmosphere having an oxygen concentration of 3 vol % or less while heating the film to give a film surface temperature of 25° C. or more.

The oxygen concentration at the transportation step after curing is preferably 3 vol % or less, more preferably 1 vol % or less. The film surface temperature on heating, the holding time of the film surface temperature, the heating method and the like are the same as those described above regarding the transportation step before curing.

The heating of the film after the irradiation with ionizing radiation provides an effect that the polymerization reaction more readily proceeds even in a polymer film produced with time.

As for the means to reduce the oxygen concentration, the air (nitrogen concentration: about 79 vol %, oxygen concentration: about 21 vol %) is preferably displaced with another inert gas, more preferably with nitrogen (nitrogen purging).

The species of the ionizing radiation for use in the present invention is not particularly limited, and appropriate ionizing radiation may be selected from an ultraviolet ray, an electron beam, a near ultraviolet ray, visible light, a near infrared ray, an infrared ray, an X-ray and the like, according to the kind of the curable composition for forming a film. In the present invention, irradiation with an ultraviolet ray is preferred. The ultraviolet curing is preferred because the polymerization speed is high, enabling compact equipment, and the compound is abundant in the selectable species and is inexpensive In the case of an ultraviolet ray, an ultrahigh-pressure mercury lamp, a high-pressure mercury lamp, a low-pressure mercury lamp, a carbon arc, a xenon arc, a metal halide lamp or the like may be utilized. In the case of electron beam irradiation, an electron beam having an energy of 50 to 1,000 keV emitted from various electron beam accelerators such as Cockroft-Walton type, van de Graaff type, resonance transformer type, insulated core transformer type, linear type, dynamitron type and high-frequency type, is used.

[Film-Forming Binder]

In view of the film strength, stability of coating solution, productivity of coating film, and the like, the main film-forming binder component of the film-forming composition for use in the present invention is preferably a compound having an ethylenically unsaturated group. The main film-forming binder component means a component occupying from 10 to 100 mass %, preferably from 20 to 100 mass %, more preferably from 30 to 95 mass %, in the film-forming components excluding an inorganic particle.

The main film-forming binder is preferably a polymer having a saturated hydrocarbon chain or a polyether chain as the main chain, more preferably a polymer having a saturated hydrocarbon chain as the main chain. Furthermore, this polymer preferably has a crosslinked structure.

The binder polymer having a saturated hydrocarbon chain as the main chain and having a crosslinked structure is preferably a (co)polymer of a monomer having two or more ethylenically unsaturated groups.

In the case of obtaining a high refractive index, the monomer structure preferably contains an aromatic ring or at least one atom selected a halogen atom excluding fluorine, a sulfur atom, a phosphorus atom and a nitrogen atom.

Examples of the monomer having two or more ethylenically unsaturated groups include an ester of a polyhydric alcohol and a (meth)acrylic acid (e.g., ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate); a vinylbenzene and a derivative thereof (e.g., 1,4-divinylbenzene, 2-acryloylethyl 4-vinylbenzoate, 1,4-divinylcyclohexanone); a vinylsulfone (e.g., divinylsulfone); an acrylamide (e.g., methylenebisacrylamide); and a methacrylamide.

These monomers may be used in combination of two or more thereof. In the present invention, the terms “(meth)acrylate”, “(meth)acryloyl” and “(meth)acrylic acid” indicate “acrylate or methacrylate”, “acryloyl or methacryloyl” and “acrylic acid or methacrylic acid”, respectively.

In addition, specific examples of the high refractive index monomer include bis(4-methacryloylthiophenyl)sulfide, vinylnaphthalene, vinylphenylsulfide and 4-methacryl-oxyphenyl-4′-methoxyphenylthioether. These monomers may also be used in combination of two or more thereof.

The polymerization of such a monomer having an ethylenically unsaturated group may be performed by the irradiation with ionizing radiation or under heating in the presence of a photoradical initiator or a thermal radical initiator.

Examples of the photoradical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borates, active esters, active halogens, inorganic complexes and coumarins.

Examples of the acetophenones include 2,2-dimethoxyacetophenone, 2,2-diethoxyacetophenone, p-dimethylacetophenone, 1-hydroxy-dimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino- 1-(4-morpholinophenyl)-butanone, 4-phenoxydichloroacetophenone and 4-tert-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone) and 3,3′,4,4′-tetra(tert-butylperoxycarbonyl)benzophenone.

Examples of the phosphine oxides include 2,4,6-trimethylbenzoyldiphenylphosphine oxide.

Examples of the active esters include 1,2-octanedione, 1-[4-(phenylthio)-2-(O-benzoyloxime)], sulfonic acid esters and cyclic active ester compounds. Specifically, Compounds 1 to 21 described in Examples of JP-A-2000-80068 are preferred.

Examples of the onium salts include an aromatic diazonium salt, an aromatic iodonium salt and an aromatic sulfonium salt.

Examples of the borate include ion complexes with a cationic coloring matter.

As for the active halogens, an S-triazine compound and an oxathiazole compound are known, and examples thereof include 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-Br-4-di(ethyl acetate)amino)phenyl)-4,6-bis(trichloromethyl)-s-triazine and 2-trihalomethyl-5-(p-methoxyphenyl)-1,3,4-oxadiazole. Specifically, the compounds described at pages 14 to 30 of JP-A-58-15503, the compounds described at pages 6 to 10 of JP-A-55-77742, Compound Nos. 1 to 8 described at page 287 of JP-B-60-27673, Compound Nos. 1 to 17 at pages 443 and 444 of JP-A-60-239736, and Compound Nos. 1 to 19 described in U.S. Pat. No. 4,701,399 are preferred.

Examples of the inorganic complex include bis-(η⁵-2,4-cyclopentadien-1-yl)-bis(2,6-difluoro-3-(1H-pyrrol-1-yl)-phenyl)titanium.

Examples of the coumarins include 3-ketocoumarin.

One of these initiators may be used alone or a mixture thereof may be used.

Various examples are also described in Saishin UV Koka Giiutsu (Latest UV Curing Technologies), page 159, Technical Information Institute Co., Ltd. (1991), and Kiyomi Kato, Shigaisen Koka System (Ultraviolet Curing System), pp. 65-148, Sogo Gijutsu Center (1989), and these are useful in the present invention.

Preferred examples of the commercially available photoradical polymerization initiator of photo-cleavage type include IRGACURE (e.g., 651, 184, 819, 907, 1870 (a 7/3 mixed initiator of CGI-403/Irg 184), 500, 369, 1173, 2959, 4265, 4263, OXE01) produced by Ciba Specialty Chemicals, KAYACURE (e.g., DETX-S, BP-100, BDMK, CTX, BMS, 2-EAQ, ABQ, CPTX, EPD, ITX, QTX, BTC, MCA) produced by Nippon Kayaku Co., Ltd., Esacure (e.g., KIP100F, KB1, EB3, BP, X33, KT046, KT37, KIP150, TZT) produced by Sartomer Company Inc., and a combination thereof.

The photoradical initiator is preferably used in an amount of 0.1 to 15 parts by mass, more preferably from 1 to 10 parts by mass, per 100 parts by mass of the polyfunctional monomer.

In addition to the photopolymerization initiator, a photosensitizer may be used. Specific examples of the photosensitizer include n-butylamine, triethylamine, tri-n-butylphosphine, Michler's ketone and thioxanthone.

Furthermore, one or more auxiliary agent such as azide compound, thiourea compound and mercapto compound may be used in combination.

Examples of the commercially available photosensitizer include KAYACURE (e.g., DMBI, EPA) produced by Nippon Kayaku Co., Ltd.

As for the thermal radical initiator, an organic or inorganic peroxide, an organic azo or diazo compound, or the like may be used.

Specifically, examples of the organic peroxide include benzoyl peroxide, halogen benzoyl peroxide, lauroyl peroxide, acetyl peroxide, dibutyl peroxide, cumene hydroperoxide and butyl hydroperoxide; examples of the inorganic peroxide include hydrogen peroxide, ammonium persulfate and potassium persulfate; examples of the organic azo compound include 2,2′-azobis(isobutyronitrile), 2,2′-azobis(propionitrile) and 1,1′-azobis(cyclohexane-carbonitrile); and examples of the diazo compound include diazoaminobenzene and p-nitrobenzenediazonium.

In the present invention, a polymer having a polyether as the main chain may also be used, and a ring-opened polymer of a polyfunctional epoxy compound is preferred. The ring-opening polymerization of a polyfunctional epoxy compound may be performed by the irradiation with ionizing radiation or under heating in the presence of a photoacid generator or a thermal acid generator. As for the photoacid generator or thermal acid generator, known compounds may be used.

A crosslinked structure may be introduced into the binder polymer by using a crosslinking functional group-containing monomer in place of or in addition to the monomer having two or more ethylenically unsaturated groups to introduce a crosslinking functional group into the polymer, and reacting the crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. In addition, a vinylsulfonic acid, an acid anhydride, a cyanoacrylate derivative, a melamine, an etherified methylol, an ester, a urethane, and a metal alkoxide (e.g., tetramethoxysilane) may also be utilized as the monomer for introducing a crosslinked structure. A functional group which exhibits a crosslinking property as a result of decomposition reaction, such as block isocyanate group, may also be used. That is, in the present invention, the crosslinking functional group may be a functional group which exhibits reactivity not directly but as a result of decomposition.

The binder polymer having such a crosslinking functional group can form a crosslinked structure by the heating after coating.

[Material for Low Refractive Index Layer]

The low refractive index layer is preferably formed from a cured film of a copolymer comprising, as essential constituent components, a repeating unit derived from a fluorine-containing vinyl monomer and a repeating unit having a (meth)acryloyl group in the side chain. The component derived from the copolymer preferably occupies 60 mass % or more, more preferably 70 mass % or more, still more preferably 80 mass % or more, in the solid content of the film. From the standpoint of satisfying both the low refractive index and the film strength, a curing agent such as polyfunctional (meth)acrylate is also preferably used in an addition amount within the range of not impairing the compatibility.

The compound described in JP-A-1 1-228631 may also be preferably used.

The refractive index of the low refractive index layer is preferably from 1.20 to 1.46, more preferably from 1.25 to 1.46, still more preferably from 1.30 to 1.46.

The thickness of the low refractive index layer is preferably 200 nm or less, more preferably from 50 to 200 nm, still more preferably from 70 to 100 nm. The haze of the low refractive index layer is preferably 3% or less, more preferably 2% or less, and most preferably 1% or less. The strength of the low refractive index layer is preferably H or more, more preferably 2H or more, and most preferably 3H or more, as specifically determined by a pencil hardness test with a load of 500 g.

Furthermore, in order to improve the antifouling performance of the antireflection film, the contact angle with water on the surface is preferably 90° or more, more preferably 95° or more, still more preferably 100° or more.

The copolymer preferably used for the low refractive index layer of the present invention is described below.

Examples of the fluorine-containing vinyl monomer include fluoroolefins (e.g., fluoroethylene, vinylidene fluoride, tetrafluoroethylene, hexafluoropropylene), partially or completely fluorinated alkyl ester derivatives of (meth)acrylic acid (for example, BISCOTE 6FM (trade name, produced by Osaka Yuki Kagaku) and R-2020 (trade name, produced by Daikin)), and completely or partially fluorinated vinyl ethers. Among these, perfluoroolefins are preferred and in view of the refractive index, solubility, transparency and easy availability, hexafluoropropylene is more preferred. When the compositional ratio of this fluorine-containing vinyl monomer is increased, the refractive index may be lowered, but the film strength decreases. In the present invention, the fluorine-containing vinyl monomer is preferably introduced so that the copolymer can have a fluorine content of 20 to 60 mass %, more preferably from 25 to 55 mass %, still more preferably from 30 to 50 mass %.

The copolymer of the present invention preferably comprises, as an essential constituent component, a repeating unit having a (meth)acryloyl group in the side chain. When the compositional ration of this (meth)acryloyl group-containing repeating unit is increased, the film strength may be enhanced, but the refractive index also becomes high. In general, the (meth)acryloyl group-containing repeating unit preferably occupies from 5 to 90 mass %, more preferably from 30 to 70 mass %, still more preferably from 40 to 60 mass %, though this may vary depending on the kind of the repeating unit derived from the fluorine-containing vinyl monomer.

In the copolymer useful for the present invention, other than the repeating unit derived from the fluorine-containing vinyl monomer and the repeating unit having a (meth)acryloyl group in the side chain, other vinyl monomers may be appropriately copolymerized from various viewpoints such as adhesion to substrate, Tg (contributing to the film hardness) of polymer, solubility in solvent, transparency, slipperiness and dust-protecting-antifouling property. A plurality of these vinyl monomers may be used in combination according to the purpose, and such a vinyl monomer is preferably introduced to occupy in total from 0 to 65 mol %, more preferably from 0 to 40 mol %, still more preferably from 0 to 30 mol %, in the copolymer.

The vinyl monomer unit which can be used in combination is not particularly limited, and examples thereof include olefins (e.g., ethylene, propylene, isoprene, vinyl chloride, vinylidene chloride), acrylic acid esters (e.g., methyl acrylate, methyl acrylate, ethyl acrylate, 2-ethylhexyl acrylate, 2-hydroxyethyl acrylate), methacrylic acid esters (e.g., methyl methacrylate, ethyl methacrylate, butyl methacrylate, 2-hydroxyethyl methacrylate), styrene derivatives (e.g., styrene, p-hydroxymethylstyrene, p-methoxystyrene), vinyl ethers (e.g., methyl vinyl ether, ethyl vinyl ether, cyclohexyl vinyl ether, hydroxyethyl vinyl ether, hydroxybutyl vinyl ether), vinyl esters (e.g., vinyl acetate, vinyl propionate, vinyl cinnamate), unsaturated carboxylic acids (e.g., acrylic acid, methacrylic acid, crotonic acid, maleic acid, itaconic acid), acrylamides (e.g., N,N-dimethylacrylamide, N-tert-butylacrylamide, N-cyclohexylacrylamide), methacrylamides (e.g., N,N-dimethylmethacrylamide) and acrylonitrile.

In the present invention, a fluorine-containing polymer represented by the following formula 1 is preferably used.
Formula 1:

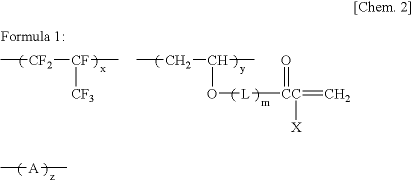

In formula 1, L represents a linking group having a carbon number of 1 to 10, preferably from 1 to 6, more preferably from 2 to 4, which may have a linear, branched or cyclic structure and may contain a heteroatom selected from O, N and S.

Preferred examples thereof include *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(CH(OH)CH₂—O** and *—CH₂CH₂OCONH(CH₂)₃—O—** (wherein * denotes a linking site on the polymer main chain side and ** denotes a linking site on the (meth)acryloyl group side). m represents 0 or 1.

In formula 1, X represents a hydrogen atom or a methyl group and in view of the curing reactivity, preferably a hydrogen atom.

In formula 1, A represents a repeating unit derived from an arbitrary vinyl monomer. The repeating unit is not particularly limited as long as it is a constituent component of a monomer copolymerizable with hexafluoropropylene, and may be appropriately selected from various viewpoints such as adhesion to substrate, Tg (contributing to film hardness) of polymer, solubility in solvent, transparency, slipperiness and dust-protecting-antifouling property. The repeating unit may comprise a single vinyl monomer or a plurality of vinyl monomers according to the purpose.

Preferred examples of the vinyl monomer include vinyl ethers such as methyl vinyl ether, ethyl vinyl ether, tert-butyl vinyl ether, cyclohexyl vinyl ether, isopropyl vinyl ether, hydroxyethyl vinyl ether, hydroxybutyl vinyl ether, glycidyl vinyl ether and allyl vinyl ether; vinyl esters such as vinyl acetate, vinyl propionate and vinyl butyrate; (meth)acrylates such as methyl (meth)acrylate, ethyl (meth)acrylate, hydroxyethyl (meth)acrylate, glycidyl methacrylate, allyl (meth)acrylate and (meth)acryloyloxypropyltrimethoxysilane; styrene derivatives such as styrene and p-hydroxymethylstyrene; unsaturated carboxylic acids such as crotonic acid, maleic acid and itaconic acid; and derivatives thereof. Among these, vinyl ether derivatives and vinyl ester derivatives are preferred, and vinyl ether derivatives are more preferred.

x, y and z represent mol % of respective constituent components and each represents a value satisfying 30≦x≦60, 5≦y≦70 and 0≦z≦65, preferably 35≦x≦55, 30≦y≦60 and 0≦z≦20, more preferably 40≦x≦55, 40≦y≦55 and 0≦z≦10.

The preferred embodiment of the copolymer for use in the present invention includes a compound represented by formula 2:
Formula 2:

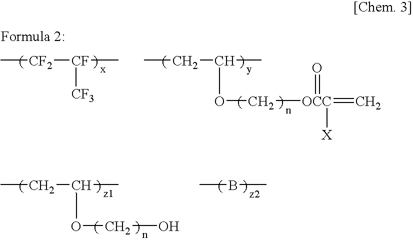

In formula 2, X, x and y have the same meanings as in formula 1 and preferred ranges are also the same.

n represents an integer of 2≦n≦10, preferably 2≦n≦6, more preferably 2≦n≦4.

B represents a repeating unit derived from an arbitrary vinyl monomer and may comprise a single composition or a plurality of compositions. Examples thereof include those described above as examples of A in formula 1.

z1 and z2 represent mol % of respective repeating units and each represents a value satisfying 0≦z1≦65 and 0≦z2≦65, preferably 0≦z1≦30 and 0≦z2≦10, more preferably 0≦z1≦10 and 0≦z2≦5.

The copolymer represented by formula 1 or 2 can be synthesized, for example, by introducing a (meth)acryloyl group into a copolymer comprising a hexafluoropropylene component and a hydroxyalkyl vinyl ether component.

Preferred examples of the copolymer useful in the present invention are set forth below, but the present invention is not limited thereto.

| | |
|---|---|
| | [Chem. 4] |
| 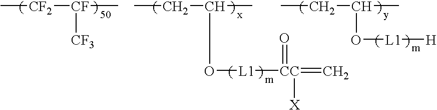 | |

| | x | y | m | L1 | X |
|---|---|---|---|---|---|
| P-1 | 50 | 0 | 1 | *—CH₂CH₂O—** | H |
| P-2 | 50 | 0 | 1 | *—CH₂CH₂O—** | CH₃ |
| P-3 | 45 | 5 | 1 | *—CH₂CH₂O—** | H |
| P-4 | 40 | 10 | 1 | *—CH₂CH₂O—** | H |
| P-5 | 30 | 20 | 1 | *—CH₂CH₂O—** | H |
| P-6 | 20 | 30 | 1 | *—CH₂CH₂O—** | H |
| P-7 | 50 | 0 | 0 | — | H |
| P-8 | 50 | 0 | 1 | *—C₄H₈—** | H |
| P-9 | 50 | 0 | 1 | * [symbol] CH₂ [symbol] ₂O [symbol] CH₂ [symbol] ₂O—** | H |
| P-10 | 50 | 0 | 1 | 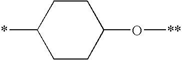 | H |

*denotes the polymer main chain side, and
**denotes the (meth)acryloyl group side

| | |
|---|---|
| | [Chem. 5] |
| 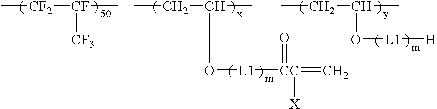 | |

| | x | y | m | L1 | X |
|---|---|---|---|---|---|
| P-11 | 50 | 0 | 1 | *—CH₂CH₂NH—** | H |
| P-12 | 50 | 0 | 1 | 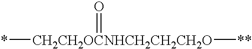 | H |
| P-13 | 50 | 0 | 1 | 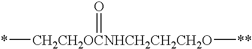 | CH₃ |
| P-14 | 50 | 0 | 1 | 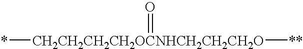 | CH₃ |
| P-15 | 50 | 0 | 1 | 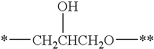 | H |
| P-16 | 50 | 0 | 1 | 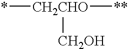 | H |
| P-17 | 50 | 0 | 1 | 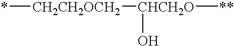 | H |
| P-18 | 50 | 0 | 1 | 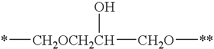 | CH₃ |
| P-19 | 50 | 0 | 1 | 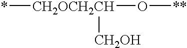 | CH₃ |
| P-20 | 40 | 10 | 1 | *—CH₂CH₂O—** | CH₃ |

*denotes the polymer main chain side, and
**denotes the (meth)acryloyl group side.

| | |
|---|---|
| | [Chem. 6] |
| 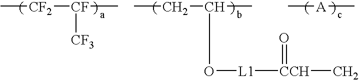 | |

| | a | b | c | L1 | A |
|---|---|---|---|---|---|
| P-21 | 55 | 45 | 0 | *—CH₂CH₂O—** | — |
| P-22 | 45 | 55 | 0 | *—CH₂CH₂O—** | — |
| P-23 | 50 | 45 | 5 | 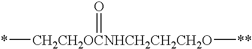 | 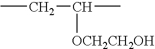 |
| P-24 | 50 | 45 | 5 | 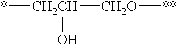 | 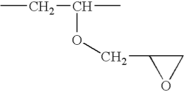 |
| P-25 | 50 | 45 | 5 | 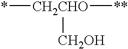 | 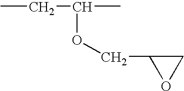 |
| P-26 | 50 | 40 | 10 | *—CH₂CH₂O—** | 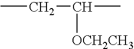 |
| P-27 | 50 | 40 | 10 | *—CH₂CH₂O—** | 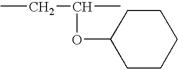 |
| P-28 | 50 | 40 | 10 | *—CH₂CH₂O—** | 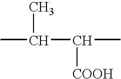 |

*denotes the polymer main chain side, and
**denotes the (meth)acryloyl group side.

| | |
|---|---|
| | [Chem. 7] |
| 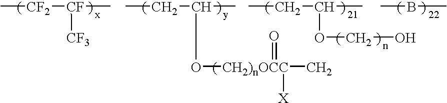 | |

| | x | y | z1 | z2 | n | X | B |
|---|---|---|---|---|---|---|---|
| P-29 | 50 | 40 | 5 | 5 | 2 | H | 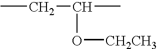 |
| P-30 | 50 | 35 | 5 | 10 | 2 | H | 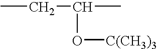 |
| P-31 | 40 | 40 | 10 | 10 | 4 | CH₃ | 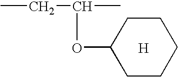 |

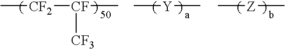

| | a | b | Y | Z |
|---|---|---|---|---|
| P-32 | 45 | 5 | 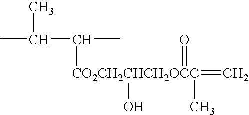 | 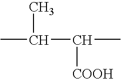 |
| P-33 | 40 | 10 | 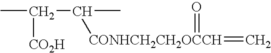 | 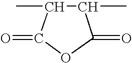 |

| | |
|---|---|
| | [Chem. 8] |
| 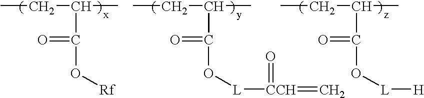 | |

| | x | y | z | Rf | L |
|---|---|---|---|---|---|
| P-34 | 60 | 40 | 0 | —CH₂CH₂C₈F₁₇-n | —CH₂CH₂O— |
| P-35 | 60 | 30 | 10 | —CH₂CH₂C₄F₈H-n | —CH₂CH₂O— |
| P-36 | 40 | 60 | 0 | —CH₂CH₂C₆F₁₂H | —CH₂CH₂CH₂CH₂O— |

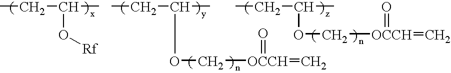

| | x | y | z | n | Rf |
|---|---|---|---|---|---|
| P-37 | 50 | 50 | 0 | 2 | —CH₂C₄F₈H-n |
| P-38 | 40 | 55 | 5 | 2 | —CH₂C₄F₈H-n |
| P-39 | 30 | 70 | 0 | 4 | —CH₂C₈F₁₇-n |
| P-40 | 60 | 40 | 0 | 2 | —CH₂CH₂C₈F₁₆H-n |

The copolymer for use in the present invention can be synthesized by the method described in JP-A-2004-45462. The synthesis of the copolymer for use in the present invention may also be performed by synthesizing a precursor such as a hydroxyl group-containing polymer according to various polymerization methods other than that described above, such as solution polymerization, precipitation polymerization, suspension polymerization, precipitation polymerization, block polymerization and emulsion polymerization, and then introducing a (meth)acryloyl group through the above-described polymer reaction. The polymerization reaction can be performed by a known operation such as batch system, semi-continuous system or continuous system.

The polymerization initiating method includes, for example, a method of using a radical initiator and a method of irradiating ionizing radiation.

These polymerization methods and polymerization initiating methods are described, for example, in Teiji Tsuruta, Kobunshi Gosei Hoho (Polymer Synthesis Method), revised edition, Nikkan Kogyo Shinbun Sha (1971), and Takayuki Ohtsu and Masaetsu Kinoshita, Kobunshi Gosei no Jikken Ho (Test Method of Polymer Synthesis), pp. 124-154, Kagaku Dojin (1972).

Among those polymerization methods, a solution polymerization method using a radical initiator is preferred. As for the solvent used in the solution polymerization, various organic solvents such as ethyl acetate, butyl acetate, acetone, methyl ethyl ketone (MEK), methyl isobutyl ketone (MIBK), cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol and 1-butanol, may be used individually or as a mixture of two or more thereof or may be used as a mixed solvent with water.

The polymerization temperature should be set in connection with, for example, the molecular weight of polymer or the kind of initiator, and a polymerization temperature from 0° C. or less to 100° C. or more can be employed, but the polymerization is preferably performed at a temperature of 50 to 100° C.

The reaction pressure can be appropriately selected but is usually from 1 to 100 kPa, preferably from 1 to 30 kPa. The reaction time is approximately from 5 to 30 hours.

The reprecipitation solvent for the polymer obtained is preferably isopropanol, hexane, methanol or the like.

The inorganic particle which can be preferably used in the low refractive index layer of the antireflection film of the present invention is described below.

The coated amount of the inorganic fine particle is preferably from 1 to 100 mg/m², more preferably from 5 to 80 mg/m², still more preferably from 10 to 60 mg/m². If the coated amount is too small, the effect of improving the scratch resistance decreases, whereas if it is excessively large, fine irregularities are generated on the low refractive index layer surface and the appearance (e.g., real black) or integrated reflectance may be deteriorated.

The inorganic fine particle is incorporated into the low refractive index layer and therefore, preferably has a low refractive index. Examples thereof include a silica fine particle and a hollow silica fine particle.

In the present invention, in order to reduce the refractive index of the low refractive index layer, a hollow silica fine particle is preferably used. The refractive index of the hollow silica fine particle is preferably from 1.15 to 1.40, more preferably from 1.17 to 1.35, and most preferably from 1.17 to 1.30. The refractive index as used herein indicates a refractive index of the particle as a whole and does not indicate a refractive index of only the outer shell silica forming the hollow silica fine particle. At this time, assuming that the radius of the cavity inside the particle is a and the radius of the outer shell of the particle is b, the porosity x represented by the following mathematical formula (VIII) is preferably from 10 to 60%, more preferably from 20 to 60%, and most preferably from 30 to 60%.
x=(4πa³/3)/(4πb³/3)×100 Formula (VIII):

If the hollow silica fine particle is made to have a more reduced refractive index and a more increased porosity, the thickness of the outer shell becomes small and the strength as a particle decreases. Therefore, in view of the scratch resistance, a particle having a low refractive index of less than 1.15 is not preferred.

The production method of the hollow silica is described, for example, in JP-A-2001-233611 and JP-A-2002-79616. In particular, a particle having a cavity inside the shell, with the pores of the shell being closed, is preferred. Incidentally, the refractive index of this hollow silica fine particle can be calculated by the method described in JP-A-2002-79616.

The coated amount of the hollow silica fine particle is preferably from 1 to 100 mg/m², more preferably from 5 to 80 mg/m², still more preferably from 10 to 60 mg/m². If the coated amount is too small, the effect of reducing the refractive index or improving the scratch resistance decreases, whereas if it is excessively large, fine irregularities are generated on the low refractive index layer surface and the appearance (e.g., real black) or integrated reflectance may deteriorate.

The average particle diameter of the hollow silica fine particle is preferably from 30 to 150%, more preferably from 35 to 80%, still more preferably from 40 to 60%, of the thickness of the low refractive index layer. In other words, when the thickness of the low refractive index layer is 100 nm, the particle diameter of the hollow silica is preferably from 30 to 150 nm, more preferably from 35 to 80 nm, still more preferably from 40 to 60 nm.

If the particle diameter of the hollow silica fine particle is too small, the proportion of the cavity part decreases and reduction in the refractive index cannot be expected, whereas if it is excessively large, fine irregularities are generated on the low refractive index layer surface and the appearance (e.g., real black) or integrated reflectance may be deteriorated. The hollow silica fine particle may be either crystalline or amorphous and is preferably a monodisperse particle. The shape is most preferably spherical but even if amorphous, there arises no problem.

Two or more kinds of hollow silica particles differing in the average particle size may be used in combination. Here, the average particle diameter of the hollow silica can be determined from an electron microphotograph.

In the present invention, the surface area of the hollow silica fine particle is preferably from 20 to 300 m 2/g, more preferably from 30 to 120 m²/g, and most preferably from 40 to 90 m²/g. The surface area can be determined by the BET method using nitrogen.

In the present invention, a silica fine particle with no cavity may be used in combination with the hollow silica fine particle. The average particle diameter of the silica fine particle with no cavity is preferably from 30 to 150%, more preferably from 35 to 80%, still more preferably from 40 to 60%, of the thickness of the low refractive index layer. In other words, when the thickness of the low refractive index layer is 100 nm, the particle diameter of the silica fine particle is preferably from 30 to 150 nm, more preferably from 35 to 80 nm, still more preferably from 40 to 60 nm.

If the particle diameter of the silica fine particle is too small, the effect of improving the scratch resistance decreases, whereas if it is excessively large, fine irregularities are generated on the low refractive index layer surface and the appearance (e.g., real black) or integrated reflectance may be deteriorated.

The silica fine particle may be either crystalline or amorphous and may be a monodisperse particle or may be even an aggregated particle as long as the predetermined particle diameter is satisfied. The shape is most preferably spherical but even if amorphous, there arises no problem.

The average particle diameter of the inorganic fine particle is measured by a Coulter counter.

At least one species of a silica fine particle having an average particle size of less than 25% of the thickness of the low refractive index layer (this fine particle is referred to as a “small particle-diameter silica fine particle”) may also be used in combination with the silica fine particle having the above-described particle diameter (this fine particle is referred to as a “large particle-diameter silica fine particle”).

The small particle-diameter silica fine particle can be present in a space between large particle-diameter silica fine particles and therefore, can contribute as a holding agent for the large particle-diameter silica fine particle.

The average particle diameter of the small particle-diameter silica fine particle is preferably from 1 to 20 nm, more preferably from 5 to 15 nm, still more preferably from 10 to 15 nm. Use of such a silica fine particle is preferred in view of the raw material cost and the holding agent effect.

For the purpose of stabilizing the dispersion in a liquid dispersion or coating solution or enhancing the affinity for or binding property with the binder component, the hollow silica fine particle or silica fine particle may be subjected to a physical surface treatment such as plasma discharge treatment and corona discharge treatment, or a chemical surface treatment with a surfactant, a coupling agent or the like. Use of a coupling agent is particularly preferred. As for the coupling agent, an alkoxy metal compound (e.g., titanium coupling agent, silane coupling agent) is preferably used. In particular, a treatment with a silane coupling agent having an acryloyl group or a methacryloyl group is effective.

This coupling agent is used as a surface treating agent for previously applying a surface treatment to the inorganic fine particle of the low refractive index layer before a coating solution for the low refractive index layer is prepared, but the coupling agent is preferably further added as an additive at the preparation of a coating solution for the low refractive index layer and incorporated into the layer.

The hollow silica fine particle or silica fine particle is preferably dispersed in a medium in advance of the surface treatment so as to reduce the load of the surface treatment. Specific examples of the surface treating agent and the catalyst which can be preferably used in the present invention include the organosilane compounds and the catalysts described in WO2004/017105.

In the present invention, from the standpoint of enhancing the film strength, a hydrolysate of an organosilane compound and/or a partial condensate (sol) thereof is preferably added. The amount of the sol added is preferably from 2 to 200 mass %, more preferably from 5 to 100 mass %, and most preferably from 10 to 50 mass %, based on the inorganic oxide particle.

In the present invention, from the standpoint of enhancing the antifouling property, the surface free energy on the antireflection film surface is preferably reduced. Specifically, a fluorine-containing compound or a compound having a polysiloxane structure is preferably used in the low refractive index layer. As for the additive having a polysiloxane structure, addition of a reactive group-containing polysiloxane (for example, KF-100T, X-22-169AS, KF-102, X-22-37011E, X-22-164B, X-22-5002, X-22-173B, X-22-174D, X-22-169AS, 161AS (all trade names, produced by Shin-Etsu Chemical Co., Ltd.), AK-5, AK-30, AK-32 (all trade names, produced by Toagosei Chemical Industry Co., Ltd.), SILAPLANE FM0725, SILAPLANE FM0721 (both trade names, produced by Chisso Corp., DMS-U22, RMS-033, RMS-083, UMS-182, DMS-H21, DMS-H31, HMS-301, FMS121, FMS123, FMS131, FMS141, FMS221 (all trade names, produced by Gelest)) is also preferred. Furthermore, the silicone-based compounds described in [Table 2] and [Table 3] of JP-A-2003-112383 may also be preferably used. Such a polysiloxane is preferably added in an amount of 0.1 to 10 mass %, more preferably from 1 to 5 mass %, based on the entire solid content of the low refractive index layer.

The polymerization of the fluorine-containing polymer may be performed by the irradiation with ionizing radiation or under heating in the presence of the above-described photoradical initiator or thermal radical initiator.

Accordingly, the low refractive index layer can be formed by preparing a coating solution containing the fluorine-containing polymer, the photoradical or thermal radical initiator and the inorganic fine particle, applying the coating solution on a transparent substrate, and curing the coating film through a polymerization reaction by the effect of ionizing radiation or heat.

[Hardcoat Layer]

The hardcoat layer has a hardcoat property for enhancing the scratch resistance of the film. Also, the hardcoat layer is preferably used for the purpose of imparting a light-diffusing property to the film by utilizing at least either one scattering of surface scattering and internal scattering. Accordingly, the hardcoat layer preferably contains a light-transparent resin for imparting a hardcoat property and a light-transparent particle for imparting a light-diffusing property and, if desired, further contains an inorganic fine particle for elevating the refractive index, preventing the crosslinking shrinkage or increasing the strength.

The thickness of the hardcoat layer is, for the purpose of imparting a hardcoat property, preferably from 1 to 10 μm, more preferably from 1.2 to 6 μm. When the thickness is within this range, a satisfactory hardcoat property is imparted and moreover, there occurs no worsening of curling or fragility and in turn no reduction in the processing suitability.

The light-transparent resin is preferably a binder polymer having a saturated hydrocarbon chain or a polyether chain as the main chain, more preferably a binder polymer having a saturated hydrocarbon chain as the main chain. Also, the binder polymer preferably has a crosslinked structure.

The binder polymer having a saturated hydrocarbon chain as the main chain is preferably a polymer of an ethylenically unsaturated monomer. The binder polymer having a saturated hydrocarbon chain as the main chain and having a crosslinked structure is preferably a (co)polymer of a monomer having two or more ethylenically unsaturated groups.

In order to more elevate the refractive index of the binder polymer, a high refractive index monomer where an aromatic ring or at least one atom selected a halogen atom excluding fluorine, a sulfur atom, a phosphorus atom and a nitrogen atom is contained in the structure of the above-described monomer, may also be selected.

Examples of the monomer having two or more ethylenically unsaturated groups include an ester of a polyhydric alcohol and a (meth)acrylic acid [e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate], an ethylene oxide-modified of such an ester, a vinylbenzene and a derivative thereof [e.g., 1,4-divinylbenzene, 2-acryloylethyl 4-vinylbenzoate, 1,4-divinylcyclohexanone], a vinylsulfone (e.g., divinylsulfone), an acrylamide (e.g., methylenebisacrylamide) and a methacrylamide. Two or more species of these monomers may be used in combination.

The polymerization of such a monomer having an ethylenically unsaturated group may be performed by the irradiation with ionizing radiation or under heating in the presence of a polymerization initiator contained in the above-described low refractive index layer.

Accordingly, the hardcoat layer can be formed by preparing a coating solution containing the monomer for the formation of light-transparent resin, such as ethylenically unsaturated monomer, the initiator capable of generating a radical upon irradiation with ionizing radiation or under heat, the light-transparent particle and, if desired, the inorganic fine particle, applying the coating solution on a transparent substrate, and curing the coating film through a polymerization reaction by the effect of ionizing radiation or heat.

In addition to the photopolymerization initiator capable of a radical upon irradiation with ionizing radiation or under heat, a photosensitizer which may be contained in the above-described low refractive index layer, may be used.

The polymer having a polyether as the main chain is preferably a ring-opened polymer of a polyfunctional epoxy compound. The ring-opening polymerization of a poly-functional epoxy compound may be performed by the irradiation with ionizing radiation or under heating in the presence of a photoacid generator or a thermal acid generator.

Accordingly, the hardcoat layer can be formed by preparing a coating solution containing the polyfunctional epoxy compound, the photoacid generator or thermal acid generator, the light-transparent particle and the inorganic fine particle, applying the coating solution on a transparent substrate, and curing the coating film through a polymerization reaction by the effect of ionizing radiation or heat.

A crosslinked structure may be introduced into the binder polymer by using a crosslinking functional group-containing monomer in place of or in addition to the monomer having two or more ethylenically unsaturated groups to introduce a crosslinking functional group into the polymer, and reacting the crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. In addition, a vinylsulfonic acid, an acid anhydride, a cyanoacrylate derivative, a melamine, an etherified methylol, an ester, a urethane, and a metal alkoxide (e.g., tetramethoxysilane) may also be utilized as the monomer for introducing a crosslinked structure. A functional group which exhibits a crosslinking property as a result of decomposition reaction, such as block isocyanate group, may also be used. That is, in the present invention, the crosslinking functional group may be a functional group which exhibits reactivity not directly but as a result of decomposition.

The binder polymer having such a crosslinking functional group can form a crosslinked structure by the heating after coating.

The haze of the hardcoat layer varies depending on the function imparted to the antireflection film.

In the case of maintaining the image sharpness, suppressing the surface reflectance and having no light-scattering function, the haze value is preferably lower, and specifically, the haze value is preferably 10% or less, more preferably 5% or less, and most preferably 2% or less.

On the other hand, in the case of imparting, in addition to the function of suppressing the surface reflectance, a function of reducing the perception of the liquid crystal panel pattern or unevenness in the color or brightness by the effect of scattering or a function of enlarging the viewing angle by utilizing the scattering, the haze value is preferably from 10 to 90%, more preferably form 15 to 80%, and most preferably from 20 to 70%.

The light-transparent particle for use in the hardcoat layer is used for the purpose of imparting an antiglare or light-diffusing property, and the average particle diameter thereof is from 0.5 to 5 μm, preferably from 1.0 to 4.0 μm.

If the average particle diameter is less than 0.5 μm, the scattering angle distribution of light expands to a wide angle and this disadvantageously brings about reduction in the resolution of letters of the display or shortage of the antiglare property due to difficult formation of surface irregularities, whereas if it exceeds 5 μm, the thickness of the hardcoat layer needs to be increased and there arises a problem such as large curling or rising of material cost.

Specific examples of the light-transparent particle include an inorganic compound particle such as silica particle and TiO₂ particle; and a resin particle such as acryl particle, crosslinked acryl particle, methacryl particle, crosslinked methacryl particle, polystyrene particle, crosslinked styrene particle, melamine resin particle and benzoguanamine resin particle. Among these, a crosslinked styrene particle, a crosslinked acryl particle, a crosslinked acryl-styrene particle and a silica particle are preferred.

The shape of the light-transparent particle may be either spherical or amorphous.

Also, two or more kinds of light-transparent particles differing in the particle diameter may be used in combination. The light-transparent particle having a larger particle diameter can impart an antiglare property, and the light-transparent particle having a smaller particle diameter can impart a different optical property. For example, when an antireflection film is attached to a high-definition display of 133 ppi or more, it is required to cause no trouble called glare in the optical performance. The glare is attributable to a phenomenon that the picture element is enlarged or reduced due to irregularities (contributing to the antiglare property) present on the film surface and the uniformity of brightness is lost. This glare can be greatly improved by using in combination a light-transparent particle having a particle diameter smaller than that of the light-transparent particle for imparting the antiglare property and having a refractive index different from that of the binder.

The particle diameter distribution of this light-transparent particle is most preferably monodisperse. Individual particles preferably have the same particle diameter as much as possible. For example, when a particle having a particle diameter 20% or more larger than the average particle diameter is defined as a coarse particle, the percentage of the coarse particle occupying in the total number of particles is preferably 1% or less, more preferably 0.1% or less, still more preferably 0.01% or less. The light-transparent particle having such a particle diameter distribution is obtained by performing the classification after the normal synthesis reaction. By increasing the number of classifications or intensifying the classification degree, a more preferred distribution can be obtained.

In view of the light-scattering effect, image resolution, white turbidity on surface, glare and the like, this light-transparent particle is preferably blended such that the light-transparent particle is contained in the formed hardcoat layer in an amount of 3 to 30 mass %, more preferably from 5 to 20 mass %, based on the entire solid content of the hardcoat layer.

The density of the light-transparent particle is preferably from 10 to 1,000 mg/m², more preferably from 100 to 700 mg/m².

The particle size distribution of the light-transparent particle is measured by a Coulter counter method, and the measured distribution is converted into the particle number distribution.

In addition to the above-described light-transparent particle, for elevating the refractive index of the hardcoat layer, the hardcoat layer preferably contains an inorganic fine particle comprising an oxide of at least one metal selected from the group consisting of titanium, zirconium, aluminum, indium, zinc, tin and antimony and having an average particle diameter of 0.2 μm or less, preferably 0.1 μm or less, more preferably 0.06 μm or less.

Conversely, for increasing the difference in the refractive index from the light-transparent particle, it is also preferred to use an oxide of silicon in the hardcoat layer using a high refractive index light-transparent particle and thereby keep lower the refractive index of the layer. The preferred particle diameter is the same as that of the above-described inorganic fine particle.

Specific examples of the inorganic fine particle for use in the hardcoat layer include TiO₂, ZrO₂, Al₂O₃, In₂O₃, ZnO, SnO₂, Sb₂O₃, ITO and SiO₂. Among these are preferred from the standpoint of elevating the refractive index. The surface of the inorganic fine particle is preferably subjected to a silane coupling treatment or a titanium coupling treatment. A surface treating agent having on the filler surface a functional group capable of reacting with the binder species is preferably used.

In the case of using such an inorganic fine particle, the amount added thereof is preferably from 10 to 90 mass %, more preferably from 20 to 80 mass %, still more preferably from 30 to 75 mass %, based on the entire mass of the hardcoat layer.

Incidentally, this inorganic fine particle has a particle diameter sufficiently smaller than the wavelength of light and therefore, causes no scattering, and the dispersion obtained by dispersing the fine particle in the binder polymer behaves as an optically uniform substance.

Furthermore, at least one of an organosilane compound, a hydrolysate of an organosilane and/or a partial condensate (sol) thereof may be used also in the hardcoat layer.

The amount of the sol component added to a layer other than the low refractive index layer is preferably from 0.001 to 50 mass %, more preferably from 0.01 to 20 mass %, still more preferably from 0.05 to 10 mass %, yet still more preferably from 0.1 to 5 mass %, based on the entire solid content of the layer containing the sol component (the layer to which the sol component is added). In the case of a hardcoat layer, the restriction on the amount added of the organosilane compound or a sol component thereof is not so severe as in the low refractive index layer and therefore, the organosilane compound is preferably used.

The bulk refractive index of the mixture of a light-transparent resin and a light-transparent particle is preferably 1.48 to 2.00, more preferably from 1.50 to 1.80. The refractive index in this range can be attained by appropriately selecting the kind and amount ratio of the light-transparent resin and light-transparent particle. How to select these can be easily known in advance by an experiment.

Also, the difference in the refractive index between the light-transparent resin and the light-transparent particle (refractive index of light-transparent particle - refractive index of light-transparent resin) is preferably from 0.02 to 0.2, more preferably from 0.05 to 0.15. When this difference is in this range, a satisfactory internal scattering effect is obtained, as a result, glare is not generated and the film surface does not become white turbid.

The refractive index of the light-transparent resin is preferably from 1.45 to 2.00, more preferably from 1.48 to 1.70.

Here, the refractive index of the light-transparent resin may be quantitatively evaluated by directly measuring the refractive index with an Abbe refractometer or by measuring a spectral reflection spectrum or a spectral ellipsometry.

Particularly, in order to prevent coating unevenness, drying unevenness, point defect or the like and ensure surface uniformity of the hardcoat layer, the coating solution for the formation of the hardcoat layer contains either a fluorine-containing surfactant or a silicone-containing surfactant or both thereof. A fluorine-containing surfactant is preferably used, because the effect of improving surface failures such as coating unevenness, drying unevenness and point defect of the antireflection film of the present invention can be brought out with a smaller amount of the surfactant added.

The purpose is to impart suitability for high-speed coating while enhancing the surface uniformity and thereby elevate the productivity.

[Antiglare Layer]

The antiglare layer is described below.

The antiglare layer is formed in the film for the purpose of imparting an antiglare property by the effect of surface scattering and also preferably imparting a hardcoat property to enhance the scratch resistance of the film. Accordingly, the antiglare layer preferably comprises, as essential components, a light-transparent resin capable of imparting a hardcoat property, a light-transparent fine particle for imparting an antiglare property, and a solvent. As for the light-transparent resin and the light-transparent fine particle, the same as those described above for the hardcoat layer may be used.

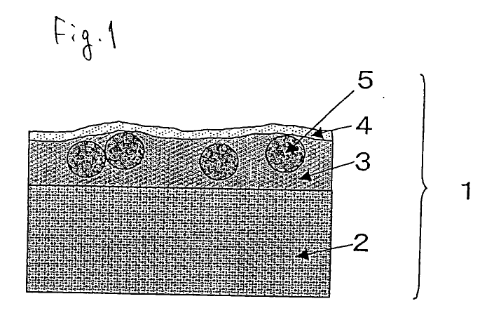

A suitable construction example of the antireflection film of the present invention is described below by referring to the drawing. FIG. 1 is a cross-sectional view schematically showing one example of the antireflection film having an antiglare property.

The antiglare antireflection film 1 shown in FIG. 1 comprises a transparent substrate 2, an antiglare layer 3 formed on the transparent substrate 2, and a low refractive index layer 4 formed on the antiglare layer 3. By forming the low refractive index layer on the antiglare layer to a thickness of around ¼ of the light wavelength, the surface reflection can be reduced by the principle of thin-film interference.

The antiglare layer 3 comprises a light-transparent resin and a light-transparent fine particle 5 dispersed in the light-transparent resin.

In the antireflection film having this constitution, the refractive indexes of the layers preferably satisfy the following relationship:

refractive index of antiglare layer >refractive index of transparent substrate>refractive index of low refractive index layer.

In the present invention, the antiglare layer having an antiglare property preferably has both an antiglare property and a hardcoat property. In this embodiment, the antiglare layer comprises one layer but may comprise a plurality of layers, for example, from 2 to 4 layers. Furthermore, the antiglare layer may be provided directly on the transparent substrate as in this embodiment but may also be provided through another layer such as antistatic layer or moisture-proof layer.

In the case of providing an antiglare layer in the antireflection film of the present invention, the film is preferably designed to have a surface irregularity profile such that the centerline average roughness Ra is from 0.08 to 0.30 μm, the 10-point average roughness Rz is 10 times or less of Ra, the average peak-to-trough distance Sm is from 1 to 100 μm, the standard deviation of the protrusion height from the deepest portion of irregularities is 0.5 μm or less, the standard deviation of the average peak-to-trough distance Sm based on the centerline is 20 μm or less, and the plane at a tilt angle of 0 to 5° occupies 10% or more, because satisfactory antiglare property and visually uniform matted texture are achieved. If the Ra is less than 0.08, a sufficiently high antiglare property may not be obtained, whereas if it exceeds 0.30, there arises a problem such as glare or whitening of the surface when outside light is reflected.

Also, when the color tint of reflected light under a C light source has a* value of -2 to 2 and b* value of −3 to 3 in the CIE 1976 L*a*b* color space and the ratio of a minimum reflectance to a maximum reflectance in the range of 380 to 780 nm is from 0.5 to 0.99, the reflected light gives a neutral color tint and this is preferred. Furthermore, the b* value of transmitted light under a C light source is preferably adjusted to 0 to 3, because when the antireflection film is applied to a display device, yellow tinting of white display is reduced.

In the case of imparting an antiglare property to the antireflection film of the present invention, the optical property thereof is preferably designed such that the haze attributed to internal scattering (hereinafter referred to as an “internal haze”) is from 5 to 20%, more preferably from 5 to 15%. If the internal haze is less than 5%, the combination of usable materials is limited to cause difficulty in the adjustment of the antiglare property and other characteristic values, and the cost rises, whereas if the internal scattering exceeds 20%, the dark room contrast is greatly worsened. Also, the haze attributed to surface scattering (hereinafter referred to as “surface haze”) is preferably from 1 to 10%, more preferably from 2 to 7%, and the transmitted image clarity at a width of 0.5 mm is preferably from 5 to 30%, because both sufficiently high antiglare property and improvement of image blurring and reduction in the dark room contrast can be satisfied. If the surface haze is less than 1%, the antiglare property is insufficient, whereas if it exceeds 10%, there arises a problem such as whitening of the surface when outside light is reflected. Furthermore, the specular reflectance is preferably 2.5% or less and the transmittance is preferably 90% or more, because the reflection of outside light can be suppressed and the visibility is enhanced.

[High (Medium) Refractive Index Layer]

In the antireflection film of the present invention, a high refractive index layer and/or a medium refractive index layer are preferably provided so as to impart a higher antireflection ability. The refractive index of the high refractive index layer in the antireflection film of the present invention is preferably from 1.60 to 2.40, more preferably from 1.70 to 2.20. The refractive index of the medium refractive index layer is adjusted to a value between the refractive index of the low refractive index layer and the refractive index of the high refractive index layer. The refractive index of the medium refractive index layer is preferably from 1.55 to 1.80. The haze of the high refractive index layer and the medium refractive index layer is preferably 3% or less. The refractive index can be appropriately adjusted by controlling the amount added of the inorganic fine particle or binder used.

For elevating the refractive index of the high (medium) refractive index layer, the layer preferably contains an inorganic fine particle comprising an oxide of at least one metal selected from the group consisting of titanium, zirconium, aluminum, indium, zinc, tin and antimony and having an average particle diameter of 0.2 μm or less, preferably 0.1 μm or less, more preferably 0.06 μm or less.

Furthermore, for increasing the difference in the refractive index from the matting particle contained in the high (medium) refractive index layer, it is also preferred to use an oxide of silicon in the high (medium) refractive index layer using a high refractive index matting particle and thereby keep lower the refractive index of the layer. The preferred particle diameter is the same as that of the inorganic fine particle in the above-described hardcoat layer.

Specific examples of the inorganic fine particle for use in the high (medium) refractive index layer include TiO₂, ZrO₂, Al₂O₃, In₂O₃, ZnO, SnO₂, Sb₂O₃, ITO and SiO₂. Among these, TiO₂ and ZrO₂ are preferred from the standpoint of elevating the refractive index. The surface of the inorganic fine particle is preferably subjected to a silane coupling treatment or a titanium coupling treatment. A surface treating agent having on the fine particle surface a functional group capable of reacting with the binder species is preferably used.

The amount of the inorganic fine particle added is adjusted according to the required refractive index but in the case of a high refractive index layer, the amount added is preferably from 10 to 90 mass %, more preferably from 20 to 80 mass %, still more preferably from 30 to 70 mass %, based on the entire mass of the layer.

Incidentally, such a fine particle has a particle diameter sufficiently smaller than the wavelength of light and therefore, causes no scattering, and the dispersion obtained by dispersing the fine particle in the binder polymer behaves as an optically uniform substance.

The high (medium) refractive index layer for use in the present invention is preferably as follows. A coating solution for the formation of the high refractive index layer is prepared by dispersing the inorganic fine particle in a dispersion medium as described above to obtain a liquid dispersion and preferably further adding thereto a binder component (for example, a monomer having two or more ethylenically unsaturated groups described above with respect to the hardcoat layer) necessary for the matrix formation, a photopolymerization initiator and the like, and the obtained coating solution for the formation of the high refractive index layer is coated on a transparent substrate and cured through a crosslinking or polymerization reaction of an ionizing radiation-curable compound (for example, a polyfunctional monomer or a polyfunctional oligomer).

For the polymerization reaction of the photopolymerizable polyfunctional monomer, a photopolymerization initiator is preferably used. The photopolymerization initiator is preferably a photoradical polymerization initiator or a photo-cationic polymerization initiator, more preferably a photoradical polymerization initiator. As for the photoradical polymerization initiator, the same as those described above for the low refractive index layer may be used.

The high (medium) refractive index layer may contain, in addition to the above-described components (e.g., inorganic fine particle, polymerization initiator, photosensitizer), a resin, a surfactant, an antistatic agent, a coupling agent, a thickening agent, a coloration inhibitor, a colorant (e.g., pigment, dye), an antiglare property-imparting particle, a defoaming agent, a leveling agent, a flame retardant, an ultraviolet absorbent, an infrared absorbent, an adhesion-imparting agent, a polymerization inhibitor, an antioxidant, a surface modifier, an electrically conducting metal fine particle and the like.

The film thickness of the high (medium) refractive index layer may be appropriately designed according to the usage. In the case of using the high (medium) refractive index layer as an optical interference layer, the film thickness is preferably from 30 to 200 nm, more preferably from 50 to 170 nm, still more preferably from 60 to 150 nm.

[Transparent Substrate]

The transparent substrate for use in the antireflection film of the present invention is preferably a plastic film. Examples of the polymer for forming the plastic film include a cellulose acylate (e.g., cellulose triacetate, cellulose diacetate, cellulose acetate propionate, cellulose acetate butyrate; as represented by TAC-TD80U and TD80UF produced by Fuji Photo Film Co., Ltd.), a polyamide, a polycarbonate, a polyester (e.g., polyethylene terephthalate, polyethylene naphthalate), a polystyrene, a polyolefin, a norbomene-based resin (ARTON, trade name, produced by JSR) and an amorphous polyolefin (ZEONEX, trade name, produced by Nippon Zeon). Among these, preferred are triacetyl cellulose, polyethylene terephthalate and polyethylene naphthalate, and more preferred is triacetyl cellulose. The cellulose acylate film containing substantially no halogenated hydrocarbon such as dichloromethane and the production method thereof are described in JIII Journal of Technical Disclosure (No. 2001-1745, issued on Mar. 15, 2001, hereinafter simply referred to as “Kokai Giho 2001-1745”), and the cellulose acylates described therein may also be preferably used in the present invention.

[Production Method of Antireflection Film]

<Formation of Antireflection Film by Coating>

The layers stacked on the transparent substrate each may be formed by coating using a dip coating method, an air knife coating method, a curtain coating method, a roller coating method, a die coating method, a wire bar coating method, a gravure coating method or an extrusion coating method (described in U.S. Pat. No. 2,681,294). Two or more layers may be simultaneously coated. The simultaneous coating method is described in U.S. Pat. Nos. 2,761,791, 2,941,898, 3,508,947 and 3,526,528, and Yuji Harasaki, Coating Kogaku (Coating Engineering), page 253, Asakura-Shoten (1973).

(Dispersion Medium for Coating)

The dispersion medium for coating is not particularly limited. One dispersion medium may be used alone, or two or more kinds of dispersion mediums may be mixed and used. Preferred examples of the dispersion medium include aromatic hydrocarbons such as toluene, xylene and styrene; chlorinated aromatic hydrocarbons such as chlorobenzene and ortho-chlorobenzene; chlorinated aliphatic hydrocarbons including methane derivatives such as monochloromethane and ethane derivatives such as monochloroethane; alcohols such as methanol, isopropyl alcohol and isobutyl alcohol; esters such as methyl acetate and ethyl acetate; ethers such as ethyl ether and 1,4-dioxane; ketones such as acetone, methyl ethyl ketone, methyl isobutyl ketone and cyclohexanone; glycol ethers such as ethylene glycol monomethyl ether; alicyclic hydrocarbons such as cyclohexane; aliphatic hydrocarbons such as normal hexane; and a mixture of aliphatic or aromatic hydrocarbons. Among these solvents, the dispersion medium for coating is preferably prepared by using one of ketones alone or a mixture of two or more species thereof.

(Filtration)

The coating solution used for the coating is preferably filtered before coating. The filtration is preferably preformed by using a filter having a pore size as small as possible within the range of not allowing for elimination of the components in the coating solution. The filter used for the filtration has an absolute filtration accuracy of 0.1 to 10 μm, preferably from 0.1 to 5 μm. The filter thickness is preferably from 0.1 to 10 mm, more preferably from 0.2 to 2 mm. In this case, the filtration is preferably performed under a pressure of 1.5 MPa or less, more preferably 1.0 MPa or less, still more preferably 0.2 MPa or less.

The filter member of filtration is not particularly limited as long as it does not affect the coating solution. Specific examples thereof are the same as those of the filtration member described above for the wet dispersion of an inorganic compound.

It is also preferred to ultrasonically disperse the filtered coating solution immediately before the coating and assist in defoaming or keeping the dispersed state of the dispersion.

<Layer Forming Method>

The production method of an antireflection film of the present invention is characterized in that at least one layer out of layers formed on the substrate film is formed by applying a coating layer and then curing it by any one of the following first to fifth methods.

(First Method)

A forming method comprising a step of curing the coating layer by irradiating ionizing radiation on the film having the coating layer in an atmosphere having an oxygen concentration lower than the oxygen concentration in the air.

(Second Method)

A forming method comprising the following steps (2) and (3), with the transportation step of (2) and the curing step of (3) being continuously performed:

(2) a step of transporting the film having the coating layer in an atmosphere having an oxygen concentration lower than the oxygen concentration in the air, and

(3) a step of curing the coating layer by irradiating ionizing radiation on the film in an atmosphere having an oxygen concentration of 3 vol % or less.

(Third Method)

A forming method comprising the following steps (2) and (3), with the transportation step of (2) and the curing step of (3) being continuously performed:

(2) a step of transporting the film having the coating layer in an atmosphere having an oxygen concentration lower than the oxygen concentration in the air, and

(3) a step of curing the coating layer by irradiating ionizing radiation on the film in an atmosphere having an oxygen concentration of 3 vol % or less while heating the film to give a film surface temperature of 25° C. or more.

(Fourth Method)

A forming method comprising the following steps (2) and (3), with the transportation step of (2) and the curing step of (3) being continuously performed:

(2) a step of transporting the film having the coating layer in an atmosphere having an oxygen concentration lower than the oxygen concentration in the air while heating the film to give a film surface temperature of 25° C. or more, and

(3) a step of curing the coating layer by irradiating ionizing radiation on the film in an atmosphere having an oxygen concentration of 3 vol % or less.

(Fifth Method)

A forming method comprising the following steps (2) and (3), with the transportation step of (2) and the curing step of (3) being continuously performed:

(2) a step of transporting the film having the coating layer in an atmosphere having an oxygen concentration lower than the oxygen concentration in the air while heating the film to give a film surface temperature of 25° C. or more, and

(3) a step of curing the coating layer by irradiating ionizing radiation on the film in an atmosphere having an oxygen concentration of 3 vol % or less while heating the film to give a film surface temperature of 25° C. or more.

These first to fifth methods each may further comprise, after the curing step of the coating layer by the irradiation with ionizing radiation, a step of transporting the cured film in an atmosphere having an oxygen concentration of 3 vol % or less while heating the film to give a film surface temperature of 25° C or more.

In order to continuously produce the antireflection film of the present invention, a step of continuously unrolling a rolled substrate film, a step of coating and drying a coating solution (that is, a step of forming a coating layer), a step of curing the coating film (coating layer), and a step of taking up the substrate film having the cured layer, are performed.

A substrate film is continuously fed from a rolled substrate film to a clean room, the static electricity charged on the substrate film is removed by a destaticizing device, and the foreign matters attached to the substrate film are then removed by a dedusting device. Subsequently, a coating solution is applied on the substrate film in the coating section provided in the clean room, and the coated substrate film is sent to a drying room and dried.

The substrate film having the dried coating layer is fed from the drying room to a radiation curing room, and radiation is irradiated on the film, as a result, the monomer contained in the coating layer is polymerized and the layer is cured. Furthermore, if desired, the substrate film having the layer cured by the effect of radiation is sent to a thermosetting section and heated, thereby completing the curing. The substrate film having the completely cured layer is taken up into a roll.

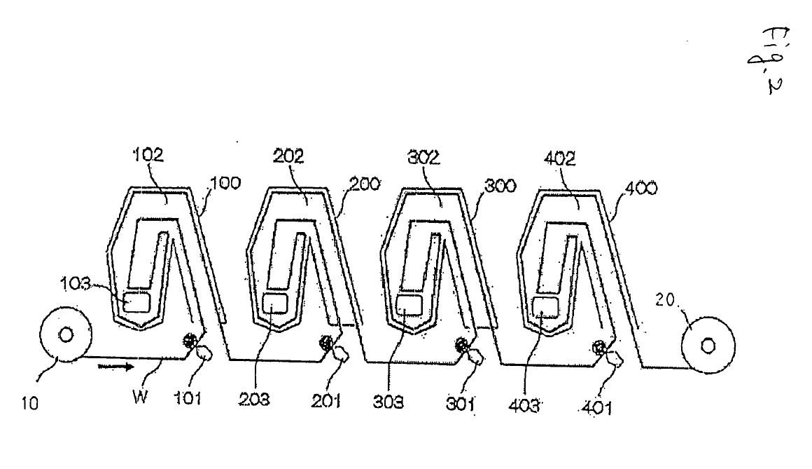

The above-described steps may be performed every formation of each layer, or respective layers may be continuously formed by providing a plurality of coating section-drying room-radiation curing section-thermosetting room systems. In view of productivity, continuous formation of respective layers is preferred. FIG. 2 shows a construction example of the apparatus for performing the continuous coating of respective layers. In this apparatus, a necessary number of film-forming units 100, 200, 300 and 400 are appropriately provided between the step 10 of continuously unrolling a rolled substrate film and the step 20 of taking up the substrate film into a roll. The apparatus shown in FIG. 2 is one example of the construction at the time of continuously coating four layers without taking up the film, and the number of film-forming units can be of course changed according to the layer construction. The film-forming unit 100 comprises a step 101 of coating a coating solution, a step 102 of drying the coating film, and a step 103 of curing the coating film. For example, in the case of producing an antireflection film having a hardcoat layer and medium, high and low refractive index layers, the antireflection film is preferably produced by a method of, with use of an apparatus comprising three film-forming units, continuously unrolling a rolled substrate film having coated thereon the hardcoat layer, sequentially coating a medium refractive index layer, a high refractive index layer and a low refractive index layer in respective film-forming units, and taking up the film; more preferably by a method of, with use of an apparatus shown in FIG. 2 comprising four film-forming units, continuously unrolling a rolled substrate film, sequentially coating a hardcoat layer, a medium refractive index layer, a high refractive index layer and a low refractive index layer in respective film-forming units, and taking up the film.

In the antireflection film of the present invention, at least a high refractive index layer and a low refractive index layer are preferably stacked. In this stack structure, when a foreign matter such as dirt or dust is present, a bright point defect distinctly appears. The bright point defect as used in the present invention means a defect visible with an eye due to reflection on the coating film, and this defect can be detected with an eye by an operation of, for example, black-painting the back surface of the antireflection film after the coating. In general, the size of the bright point defect visible with an eye is 50 μm or more. When the number of bright point defects is large, the yield at the production decreases and a large-area antireflection film cannot be produced.

In the antireflection film of the present invention, the number of bright point defects is 20 or less, preferably 10 or less, more preferably 5 or less, still more preferably 1 or less, per square meter.

The means for preparing an antireflection film with a small number of bright point defects includes the precise control of dispersity of high refractive index ultrafine particles in the coating solution for high refractive index layer and the operation of ultrafiltering the coating solution.

At the same time, the layers constituting the antireflection layer each is preferably formed under the conditions that the coating step in the coating section and the drying step in the drying room are performed in an atmosphere having a high air cleanliness and the dirt or dust on the film is thoroughly removed before performing the coating. The air cleanliness in the coating step and the drying step is preferably class 10 (the number of particles of 0.5 μm or more is not more than 353/(cubic meter)) or more, more preferably class 1 (the number of particles of 0.5 μm or more is not more than 35.5/(cubic meter)) or more, according to the air cleanliness defined in U.S. Federal Standard 209E. It is more preferred that the air cleanliness is high also in the sections other than the coating-drying steps, such as unrolling section and take-up section.

Examples of the dedusting method for use in the dedusting step as a pre-step before the coating include a dry dedusting method such as a method of pressing a nonwoven fabric or a blade against the film surface described in JP-A-59-150571; a method of blowing air having a high cleanliness at a high speed to separate attached matters from the film surface, and sucking these matters via a proximate suction port described in JP-A-10-309553; and a method of blowing compressed air under ultrasonic vibration to separate attached matters, and sucking these matters described in JP-A-7-333613 (for example, NEW ULTRA-CLEANER manufactured by Shinko Co., Ltd.).

Also, a wet dedusting method may be used, such as a method of introducing a film into a washing tank, and separating attached matters by using an ultrasonic vibrator; a method of supplying a cleaning solution to a film, and blowing air at a high speed, followed by sucking described in JP-B-49-13020; and a method of continuously rubbing a web with a liquid-moistened roll, and jetting a liquid onto the rubbed face, thereby cleaning the web described in JP-A-2001-38306. Among these dedusting methods, an ultrasonic dedusting method and a wet dedusting method are preferred in view of the dedusting effect.

Before performing such a dedusting step, the static electricity on the substrate film is preferably removed so as to elevate the dedusting effect and prevent attachment of dirt. As for the destaticizing method, an ionizer of corona discharge type, an ionizer of light irradiation type (e.g., UV, soft X-ray), and the like may be used. The voltage charged on the substrate film before and after the dedusting and coating is preferably 1,000 V or less, more preferably 300 V or less, still more preferably 100 V or less.

In the production method of the present invention, as long as the step of irradiating ionizing radiation, the transportation step before the irradiation with ionizing radiation, and the heating step performed, if desired, after the irradiation with ionizing radiation each is performed in a low oxygen concentration atmosphere (low oxygen concentration zone) controlled to a desired oxygen concentration, these steps may be divided from each other or may be continued. From the standpoint of reducing the production cost, the inert gas used for decreasing the oxygen concentration in the ionizing radiation irradiation zone is preferably discharged to a low oxygen concentration zone for performing the previous step (low oxygen concentration zone before irradiation) and/or a low oxygen concentration zone for performing the subsequent step (low oxygen concentration zone after irradiation) so as to effectively utilize the inert gas.

Not only these steps but also any step may be performed in a low oxygen concentration atmosphere. In the case of performing the irradiation with ionizing radiation by dividing the ionizing radiation irradiation zone into a plurality of zones, a low oxygen concentration zone may be provided between respective zones.

[Polarizing Plate]

The polarizing plate mainly comprises a polarizing film and two protective films sandwiching the polarizing film from both sides. The antireflection film of the present invention is preferably used for at least one protective film out of two protective films sandwiching the polarizing film from both sides. By arranging the antireflection film of the present invention to serve also as a protective film, the production cost of the polarizing plate can be reduced. Furthermore, by using the antireflection film of the present invention as an outermost surface layer, a polarizing plate prevented from the projection or the like of outside light and excellent also in the scratch resistance, antifouling property and the like can be obtained.

As for the polarizing film, a known polarizing film or a polarizing film cut out from a lengthy polarizing film with the absorption axis of the polarizing film being neither parallel nor perpendicular to the longitudinal direction, may be used. The lengthy polarizing film with the absorption axis of the polarizing film being neither parallel nor perpendicular to the longitudinal direction is produced by the following method.

This is a polarizing film obtained through stretching by applying a tension to a continuously fed polymer film while holding both edges of the film with holding means and can be produced according to a stretching method where the film is stretched to 1.1 to 20.0 times at least in the film width direction, the holding devices at both edges of the film are moved to create a difference in the travelling speed of 3% or less in the longitudinal direction, and the film travelling direction is bent, in the state of the film being held at both edges, such that the angle made by the film travelling direction at the outlet in the step of holding both edges of the film and the substantial stretching direction of the film inclines at 20 to 70°. Particularly, a polarizing film produced with an inclination angle of 45° is preferred in view of productivity.

The stretching method of a polymer film is described in detail in JP-A-2002-86554 (paragraphs [0020] to [0030]).

[Saponification Treatment]

In the case of using the antireflection film of the present invention for a liquid crystal display device, the antireflection film is disposed on the outermost surface of the display, for example, by providing a pressure-sensitive adhesive layer on one surface. Also, the antireflection film of the present invention may be combined with a polarizing film. In the case where the transparent substrate is triacetyl cellulose, since triacetyl cellulose is used as a protective film for protecting the polarizing layer of the polarizing plate, the antireflection film of the present invention is in view of the cost preferably used directly as the protective film.

In the case where the antireflection film of the present invention is disposed on the outermost surface of a display, for example, by providing a pressure-sensitive adhesive layer on one surface or is used directly as the protective film of a polarizing plate, after an outermost layer mainly comprising a fluorine-containing polymer is formed on the transparent substrate, a saponification treatment is preferably performed so as to ensure satisfactory adhesion. The saponification treatment is performed by a known method, for example, by dipping the film in an alkali solution for an appropriate time period. After dipping in an alkali solution, the film is preferably well washed with water or dipped in a dilute acid to neutralize the alkali component and allow for no remaining of the alkali component in the film.

By performing a saponification treatment, the surface of the transparent substrate on the side opposite the surface having the outermost layer is hydrophilized.

The hydrophilized surface is effective particularly for improving the adhesive property to a polarizing film mainly comprising a polyvinyl alcohol. Furthermore, the hydrophilized surface hardly allows for attachment of dust in air and therefore, dust scarcely intrudes into the space between the polarizing film and the antireflection film at the bonding to a polarizing film, so that point defects due to dust can be effectively prevented.

The saponification treatment is preferably performed such that the surface of the transparent substrate on the side opposite the surface having the outermost layer has a contact angle with water of 40° or less, more preferably 30° or less, still more preferably 20° or less.

The method for the alkali saponification treatment can be specifically selected from the following two methods (1) and (2). The method (1) is advantageous in that the treatment can be performed by the same process as that for the general-purpose triacetyl cellulose film, but since the antireflection layer surface is also saponified, there may arise a problem that the antireflection layer deteriorates resulting from alkali hydrolysis of the surface or when the solution for saponification treatment remains, this causes staining. In such a case, the method (2) is advantageous, though this is a special process.

(1) After the formation of an antireflection layer on a transparent substrate, the substrate is dipped at least once in an alkali solution, whereby the back surface of the film is saponified.

(2) Before or after the formation of an antireflection layer on a transparent support, an alkali solution is applied to the surface of the antireflection film on the side opposite the surface for forming an antireflection film, and then the film is heated and washed with water and/or neutralized, whereby only the back surface of the film is saponified.

[Image Display Device]

In the case of using the antireflection film of the present invention as the surface protective film on one side of a polarizing film, the antireflection film can be used preferably for a transmissive, reflective or transflective liquid crystal display device in a mode such as twisted nematic (TN) mode, super-twisted nematic (STN) mode, vertical alignment (VA) mode, in-plane switching (IPS) mode or optically compensated bend cell (OCB) mode.

The VA-mode liquid crystal cell includes (1) a VA-mode liquid crystal cell in a narrow sense where rod-like liquid crystalline molecules are oriented substantially in the vertical alignment at the time of not applying a voltage and oriented substantially in the horizontal alignment at the time of applying a voltage (described in JP-A-2-176625); (2) a (MVA-mode) liquid crystal cell where the VA mode is modified to a multi-domain system for enlarging the viewing angle (described in SID97, Digest of Tech. Papers (preprints), 28, 845 (1997)); (3) a (n-ASM-mode) liquid crystal cell where rod-like liquid crystalline molecules are oriented substantially in the vertical alignment at the time of not applying a voltage and oriented in the twisted multi-domain alignment at the time of applying a voltage (described in preprints of Nippon Ekisho Toronkai (Liquid Crystal Forum of Japan), 58-59 (1998)); and (4) a SURVAIVAL-mode liquid crystal cell (reported in LCD International 98).

For the application to a VA-mode liquid crystal cell, a polarizing plate prepared by combining a biaxially stretched triacetyl cellulose film with the antireflection film of the present invention is preferred. As for the production method of a biaxially stretched triacetyl cellulose film, the method described, for example, in JP-A-2001-249223 and JP-A-2003-170492 is preferably used.

The OCB-mode liquid crystal cell is a liquid crystal display device using a liquid crystal cell of bend alignment mode where rod-like liquid crystalline molecules are aligned substantially in opposite directions (symmetrically) at the upper part and the lower part of the liquid crystal cell, and this is disclosed in U.S. Pat. Nos. 4,583,825 and 5,410,422. Since rod-like liquid crystalline molecules are aligned symmetrically between the upper part and the lower part of the liquid crystal cell, the liquid crystal cell of bend alignment mode has a self-optically compensating ability. Accordingly, this liquid crystal mode is also called an OCB (optically compensatory bend) liquid crystal mode. A liquid crystal display device of bend alignment mode is advantageous in that the response speed is fast.

In the TN-mode liquid crystal cell, rod-like liquid crystalline molecules are oriented substantially in the horizontal alignment at the time of not applying a voltage. This is most popularly used as a color TFT liquid crystal display device and is described in a large number of publications such as EL, PDP LCD Display, Toray Research Center (2001).

Particularly, in the case of a TN-mode or IPS-mode liquid crystal display device, as described in JP-A-2001-100043 and the like, an optical compensation film having an effect of enlarging the viewing angle is preferably used for the protective film on the surface opposite the antireflection film of the present invention out of front and back two protective films of a polarizing film, because a polarizing plate having an antireflection effect and a viewing angle-enlarging effect with a thickness of one polarizing plate can be obtained.

### EXAMPLES

### Example 1

The present invention is described in greater detail below by referring to Examples, but the present invention should not be construed as being limited thereto.

In Examples, the “parts” indicates “parts by mass”.

(Preparation of Coating Solution for Hardcoat Layer)

The following composition was charged into a mixing tank and stirred to prepare a coating solution for hardcoat layer.

To 750.0 parts by weight of trimethylolpropane triacrylate (BISCOTE #295 (produced by Osaka Yuki Kagaku)), 270.0 parts by mass of polyglycidyl methacrylate having a mass average molecular weight of 15,000, 730.0 parts by mass of methyl ethyl ketone, 500.0 parts by mass of cyclohexanone, and 50.0 parts by mass of a photopolymerization initiator (IRGACURE 184, produced by Ciba Specialty Chemicals) were added and stirred. The resulting solution was filtered through a polypropylene-made filter having a pore size of 0.4 μm to prepare a coating solution for hardcoat layer. The polyglycidyl methacrylate was obtained by dissolving glycidyl methacrylate in methyl ethyl ketone (MEK), allowing the reaction to proceed at 80° C. for 2 hours while adding dropwise a thermopolymerization initiator (V-65 (produced by Wako Pure Chemical Industries, Ltd.)), adding dropwise hexane to the obtained reaction solution, and drying the precipitate under reduced pressure.

(Preparation of Liquid Dispersion of Titanium Dioxide Fine Particle)

As for the titanium dioxide fine particle, a cobalt-containing titanium dioxide fine particle surface-treated by using aluminum hydroxide and zirconium hydroxide (MPT-129C, produced by Ishihara Sangyo Kaisha Ltd., TiO₂:Co₃O₄:Al₂O₃:ZrO₂=90.5:3.0:4.0:0.5 by weight) was used.

After adding 41.1 parts by mass of a dispersant shown below and 701.8 parts by mass of cyclohexanone to 257.1 parts by mass of the titanium dioxide fine particle above, the mixture was dispersed by a Dyno-mill to prepare a titanium dioxide liquid dispersion having a weight average diameter of 70 nm.
Dispersant: 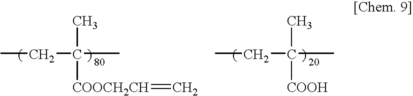
(Preparation of Coating Solution for Medium Refractive Index Layer)

To 99.1 parts by mass of the titanium dioxide liquid dispersion prepared above, 68.0 parts by mass of a dipentaerythritol pentaacrylate and dipentaerythritol hexaacrylate mixture (DPHA, produced by Nippon Kayaku Co., Ltd.), 3.6 parts by mass of a photopolymerization initiator (IRGACURE 907, produced by Ciba Specialty Chemicals), 1.2 parts by mass of a photosensitizer (KAYACURE DETX, produced by Nippon Kayaku Co., Ltd.), 279.6 parts by mass of methyl ethyl ketone, and 1,049.0 parts by mass of cyclohexanone were added and stirred. After thorough stirring, the resulting solution was filtered through a polypropylene-made filter having a pore size of 0.4 μm to prepare a coating solution for medium refractive index layer.

(Preparation of Coating Solution for High Refractive Index Layer)

To 469.8 parts by mass of the titanium dioxide liquid dispersion prepared above, 40.0 parts by mass of a dipentaerythritol pentaacrylate and dipentaerythritol hexaacrylate mixture (DPHA, produced by Nippon Kayaku Co., Ltd.), 3.3 parts by mass of a photopolymerization initiator (IRGACURE 907, produced by Ciba Specialty Chemicals), 1.1 parts by mass of a photosensitizer (KAYACURE DETX, produced by Nippon Kayaku Co., Ltd.), 526.2 parts by mass of methyl ethyl ketone, and 459.6 parts by mass of cyclohexanone were added and stirred. The resulting solution was filtered through a polypropylene-made filter having a pore size of 0.4 μpm to prepare a coating solution for high refractive index layer.

(Preparation of Coating Solution for Low Refractive Index Layer)

Copolymer P-3 shown above according to the present invention was dissolved in methyl isobutyl ketone (MIBK) to give a concentration of 7 mass %. Thereto, a terminal methacrylate group-containing silicone resin, X-22-164C (produced by Shin-Etsu Chemical Co., Ltd.), in an amount of 3% based on the solid content and a photoradical generator, IRGACURE OXE01 (trade name), in an amount of 5 mass % based on the solid content were added to prepare a coating solution for low refractive index layer.

(Production of Antireflection Film 101)

On a 80 μm-thick triacetyl cellulose film (TD80UF, produced by Fuji Photo Film Co., Ltd.), the coating solution for hardcoat layer was coated by using a gravure coater. After drying at 1 00° C., the coating layer was cured by irradiating thereon an ultraviolet ray at an illumination intensity of 400 mW/cm² and an irradiation dose of 300 mJ/cm² with use of an air-cooled metal halide lamp of 160 W/cm (manufactured by Eye Graphics Co., Ltd.) while purging the system with nitrogen to provide an atmosphere having an oxygen concentration of 1.0 vol % or less, whereby a 8 μm-thick hardcoat layer was formed.

On the hardcoat layer, the coating solution for medium refractive index layer, the coating solution for high refractive index layer, and the coating solution for low refractive index layer were continuously coated by using a gravure coater having three coating stations.

The medium refractive index layer was formed by setting the drying conditions to 90° C. and 30 seconds and the ultraviolet curing conditions to an illumination intensity of 400 mW/cm² and an irradiation dose of 400 mJ/cm² with use of an air-cooled metal halide lamp of 180 W/cm (manufactured by Eye Graphics Co., Ltd.) while purging the system with nitrogen to provide an atmosphere having an oxygen concentration of 1.0 vol % or less.

The medium refractive index layer after curing had a refractive index of 1.630 and a thickness of 67 nm.

The high refractive index layer was formed by setting the drying conditions to 90° C. and 30 seconds and the ultraviolet curing conditions to an illumination intensity of 600 mW/cm and an irradiation dose of 400 mJ/cm² with use of an air-cooled metal halide lamp of 240 W/cm (manufactured by Eye Graphics Co., Ltd.) while purging the system with nitrogen to provide an atmosphere having an oxygen concentration of 1.0 vol % or less.

The high refractive index layer after curing had a refractive index of 1.905 and a thickness of 107 nm.

The low refractive index layer was formed by setting the drying conditions to 90° C. and 30 seconds and the ultraviolet curing conditions to an illumination intensity of 600 mW/cm and an irradiation dose of 600 mJ/cm² with use of an air-cooled metal halide lamp of 240 W/cm (manufactured by Eye Graphics Co., Ltd.) while purging the system with nitrogen to provide an atmosphere having an oxygen concentration of 0.1 vol % or less.

The low refractive index layer after curing had a refractive index of 1.440 and a thickness of 85 nm. In this way, Antireflection Film 101 was produced.

Samples 102 to 112 were produced by changing only the curing conditions of the low refractive index layer to the conditions shown in Table 1. In the case of heating the film after the ultraviolet irradiation, this was performed by bringing the film after irradiation into contact with a rotating metal roll through which warm water or pressurized steam was passed. Incidentally, the film temperature of the samples not subjected to heating (for example, Sample 101) is attributable to the reaction heat at the ultraviolet irradiation.

TABLE 1

| | | | | | | Conditions in the Step Subsequent to Ultraviolet | | | | |
|---|---|---|---|---|---|---|---|---|---|---|
| | Ultraviolet Irradiation Conditions | | | | | Irradiation Step | | | | |
| | Oxygen | Irradiation | Presence or | Film | Heating | Oxygen | Presence or | Film | Heating | |
| | Concentration | Dose | Absence of | Temperature | Time | Concentration | Absence of | Temperature | Time | |
| Sample No. | (vol %) | (mJ/cm²) | Heating | (° C.) | (sec.) | (vol %) | Heating | (° C.) | (sec.) | Remarks |
| 101 | 0.1 | 600 | none | 25 | — | 21 | none | — | — | Invention |
| 102 | 21 | 600 | none | 25 | — | 21 | none | — | — | Comparison |
| 103 | 0.1 | 600 | heated | 30 | 30 | 21 | none | — | — | Invention |
| 104 | 0.1 | 600 | heated | 60 | 30 | 21 | none | — | — | Invention |
| 105 | 0.1 | 600 | heated | 100 | 30 | 21 | none | — | — | Invention |
| 106 | 0.1 | 600 | heated | 100 | 30 | 0.1 | heated | 30 | 30 | Invention |
| 107 | 0.1 | 600 | heated | 100 | 30 | 0.1 | heated | 60 | 30 | Invention |
| 108 | 0.1 | 600 | heated | 100 | 30 | 0.1 | heated | 100 | 30 | Invention |
| 109 | 21 | 600 | heated | 100 | 30 | 0.1 | heated | 100 | 30 | Comparison |
| 110 | 21 | 600 | heated | 100 | 30 | 21 | heated | 100 | 30 | Comparison |
| 111 | 0.1 | 300 | heated | 100 | 30 | 0.1 | heated | 100 | 30 | Invention |
| 112 | 0.1 | 300 | heated | 100 | 30 | 0.1 | none | — | — | Invention |

The obtained film was evaluated on the following items. The results are shown in Table 2.

[Specular Reflectance]

An adapter, ARV-474, was loaded in a spectral hardness meter, V-550 (manufactured by JASCO Corp.), and the specular reflectance of an outgoing angle -5° at an incidence angle of 5° was measured in the wavelength region of 380 to 780 nm. The average reflectance at 450 to 650 nm was calculated to evaluate the antireflection property.

[Pencil Hardness]

The evaluation of pencil hardness described in JIS K 5400 was performed. The antireflection film was moisture-conditioned at a temperature of 25° C. and a humidity of 60% RH for 2 hours and then evaluated according to the following criteria by using H to 5H pencils for test specified in JIS S 6006 under a load of 500 g. The highest pencil hardness that gave a rating of “OK” was taken as a value for evaluation.

OK: In the evaluation of n=5, no scratch or one scratch.

NG: In the evaluation of n=5, three or more scratches.

[Steel Wool Rubbing Resistance]

A #0000 steel wool was moved back and force 30 times under a load of 1.96 N/cm², and the scratched state was observed and evaluated on the following 5-stage scale.

⊚: No scratch at all.

◯: Hardly visible scratches slightly appeared.

Δ: Clearly visible scratches appeared.

×: Clearly visible scratches considerably appeared.

××: Separation of the film occurred.

TABLE 2

| Sample | Reflectance | | Steel Wool | |
|---|---|---|---|---|
| No. | (%) | Pencil Hardness | Resistance | Remarks |
| 101 | 0.32 | 2H to 3H | Δ | Invention |
| 102 | 0.32 | 2H | XX | Comparison |
| 103 | 0.32 | 2H to 3H | Δ | Invention |
| 104 | 0.32 | 2H to 3H | Δ to ◯ | Invention |
| 105 | 0.32 | 3H | ◯ | Invention |
| 106 | 0.32 | 3H | ⊚ | Invention |
| 107 | 0.32 | 3H | ⊚ | Invention |
| 108 | 0.32 | 3H | ⊚ | Invention |
| 109 | 0.32 | 2H | X | Comparison |
| 110 | 0.32 | 2H | X | Comparison |
| 111 | 0.32 | 3H | ◯ to ⊚ | Invention |
| 112 | 0.32 | 2H to 3H | ◯ | Invention |

It is seen that by virtue of the forming conditions of the present invention, the antireflection film of the present invention has sufficiently high antireflection performance, nevertheless, exhibits also excellent scratch resistance. In addition, the after-heating time is preferably 0.1 second or more.

Furthermore, in the present invention, stable performance can be ensured even when the oxygen concentration or irradiation dose at the ultraviolet irradiation fluctuates.

### Example 2

Samples 113 to 118 were produced with the only exception of passing the film through a nitrogen-purged zone before the ultraviolet irradiation zone in the production methods of Samples 102, 103, 104, 105, 108 and 109 of Example 1, and evaluated in the same manner. Samples 119 and 120 were produced with the only exception of passing the film through a nitrogen-substituted zone before the ultraviolet irradiation zone in the production method of Sample 105 of Example 1.

In the case of heating the film after the ultraviolet irradiation, this was performed by bringing the film after irradiation into contact with a rotating metal roll through which warm water or pressurized steam was passed.

TABLE 3

| | Conditions of | | | | | | | |
|---|---|---|---|---|---|---|---|---|
| | Nitrogen-Purged Zone | | | | | | | |
| | Before Ultraviolet Irradiation | | Ultraviolet Irradiation Conditions | | | | | |
| | Oxygen | | Oxygen | | Presence or | Film | Heating | |
| Sample | Concentration | Time Spent | Concentration | Irradiation Dose | Absence of | Temperature | Time | |
| No. | (vol %) | Passing (sec.) | (vol %) | (mJ/cm²) | Heating | (° C.) | (sec.) | Remarks |
| 102 | — | — | 21 | 600 | none | 25 | — | Comparison |
| 103 | — | — | 0.1 | 600 | heated | 30 | 30 | Invention |
| 104 | — | — | 0.1 | 600 | heated | 60 | 30 | Invention |
| 105 | — | — | 0.1 | 600 | heated | 100 | 30 | Invention |
| 108 | — | — | 0.1 | 600 | heated | 100 | 30 | Invention |
| 109 | — | — | 21 | 600 | heated | 100 | 30 | Comparison |
| 113 | 0.1 | 1 | 21 | 600 | none | 25 | — | Comparison |
| 114 | 0.1 | 1 | 0.1 | 600 | heated | 30 | 30 | Invention |
| 115 | 0.1 | 1 | 0.1 | 600 | heated | 60 | 30 | Invention |
| 116 | 0.1 | 1 | 0.1 | 600 | heated | 100 | 30 | Invention |
| 117 | 0.1 | 1 | 0.1 | 600 | heated | 100 | 30 | Invention |
| 118 | 0.1 | 1 | 21 | 600 | heated | 100 | 30 | Comparison |
| 119 | 10 | 1 | 0.1 | 600 | heated | 100 | 30 | Invention |
| 120 | 15 | 1 | 0.1 | 600 | heated | 100 | 30 | Invention |

The results are shown in Table 4. By virtue of passing the film through a nitrogen-purged zone with a low oxygen concentration before the ultraviolet irradiation, enhancement of the scratch resistance is obtained. By the combination with the step of passing the film through a heated nitrogen-purged zone with a low oxygen concentration after the ultraviolet irradiation, the curing becomes prominent.

Furthermore, enhancement of the scratch resistance was obtained also by heating the nitrogen-purged zone with a low oxygen concentration before the ultraviolet irradiation.

TABLE 4

| | | Pencil | Steel Wool | |
|---|---|---|---|---|
| Sample No. | Reflectance (%) | Hardness | Resistance | Remarks |
| 102 | 0.32 | 2H | XX | Comparison |
| 103 | 0.32 | 2H to 3H | Δ | Invention |
| 104 | 0.32 | 2H to 3H | Δ to ◯ | Invention |
| 105 | 0.32 | 3H | ◯ | Invention |
| 108 | 0.32 | 3H | ⊚ | Invention |
| 109 | 0.32 | 2H | X | Comparison |
| 113 | 0.32 | 3H | X to Δ | Comparison |
| 114 | 0.32 | 3H | ⊚ | Invention |
| 115 | 0.32 | 3H | ⊚ | Invention |
| 116 | 0.32 | 4H | ⊚ | Invention |
| 117 | 0.32 | 4H | ⊚ | Invention |
| 118 | 0.32 | 2H to 3H | ◯ | Comparison |
| 119 | 0.32 | 4H | ◯ to ⊚ | Invention |
| 120 | 0.32 | 4H | ◯ to ⊚ | Invention |

### Example 3

The fluorine-containing polymer used in the low refractive index layer in Examples 1 and 2 was changed to P-1 or P-2 shown above (equivalent mass change), and the samples were evaluated in the same manner, as a result, the same effects as in Examples 1 and 2 were obtained.

### Example 4

(Preparation of Coating Solution for Hardcoat Layer)

The following composition was charged into a mixing tank and stirred to prepare a coating solution for hardcoat layer.

Composition of Coating Solution for Hardcoat Layer

| | |
|---|---|
| DESOLITE Z-7404 (zirconia fine particle- | 100 parts by mass |
| containing hardcoat composition, solid content | |
| concentration: 60 wt %, | |
| zirconia fine particle content: 70 wt % based on | |
| solid content, average particle diameter: about | |
| 20 nm, solvent composition: MIBK:MEK = 9:1, | |
| containing an initiator, produced by JSR Corp.} | |
| DPHA (UV-curable resin, produced by Nippon | 31 parts by mass |
| Kayaku Co., Ltd.) | |
| KBM-5103 (silane coupling agent, produced by | 10 parts by mass |
| Shin-Etsu Chemical Co., Ltd.) | |
| KE-P150 (silica particle of 1.5 μm, produced by | 8.9 parts by mass |
| Nippon Shokubai Co., Ltd.) | |
| MXS-300 (crosslinked PMMA particle of 3 μm, | 3.4 parts by mass |
| produced by The Soken Chemical & Engineering | |
| Co., Ltd.) | |
| MEK | 29 parts by mass |
| MIBK | 13 parts by mass |

(Preparation of Coating Solution for Low Refractive Index Layer)

A coating solution for low refractive index layer was prepared in the same manner as in Example 1.

(Production of Antireflection Film 401)

A triacetyl cellulose film (TD80U, produced by Fuji Photo Film Co., Ltd.) in a roll form was unrolled as the transparent substrate, and the coating solution for hardcoat layer prepared above was coated thereon by using a doctor blade and a microgravure roll having a diameter of 50 mm and having a gravure pattern with a line number of 135 lines/inch and a depth of 60 μm under the condition of a transportation speed of 10 m/min and after drying at 60° C. for 150 seconds, irradiated with an ultraviolet ray at an illumination intensity of 400 mW/cm² and an irradiation dose of 250 mJ/cm² by using an air-cooled metal halide lamp of 160 W/cm (manufactured by Eye Graphics Co., Ltd.) under nitrogen purging, thereby curing the coating layer to form a hardcoat layer. The resulting film was taken up. The rotation number of the gravure roll was adjusted to give a hardcoat layer thickness of 3.6 μm after curing.

The transparent substrate having coated thereon the hardcoat layer was again unrolled, and the coating solution for low refractive index layer prepared above was coated thereon by using a doctor blade and a microgravure roll having a diameter of 50 mm and having a gravure pattern with a line number of 200 lines/inch and a depth of 30 μm under the condition of a transportation speed of 10 m/min and after drying at 90° C. for 30 seconds, irradiated with an ultraviolet ray at an illumination intensity of 600 mW/cm² and an irradiation dose of 400 mJ/cm² by using an air-cooled metal halide lamp of 240 W/cm (manufactured by Eye Graphics Co., Ltd.) in an atmosphere having an oxygen concentration of 0.1 vol % to form a low refractive index layer. The resulting film was taken up. The rotation number of the gravure roll was adjusted to give a low refractive index layer thickness of 100 nm after curing. In the case of heating the film after the ultraviolet irradiation, this was performed by bringing the film after irradiation into contact with a rotating metal roll through which warm water or pressurized steam was passed.

Samples 402 to 412 were produced by changing the curing conditions of the low refractive index as shown in Table 5.

TABLE 5

| | | | | | | Conditions in the Step Subsequent to Ultraviolet | | | | |
|---|---|---|---|---|---|---|---|---|---|---|
| | Ultraviolet Irradiation Conditions | | | | | Irradiation Step | | | | |
| | Oxygen | Irradiation | Presence or | Film | Heating | Oxygen | Presence or | Film | Heating | |
| | Concentration | Dose | Absence of | Temperature | Time | Concentration | Absence of | Temperature | Time | |
| Sample No. | (vol %) | (mJ/cm²) | Heating | (° C.) | (sec.) | (vol %) | Heating | (° C.) | (sec.) | Remarks |
| 401 | 0.1 | 600 | none | 25 | — | 21 | none | — | — | Invention |
| 402 | 21 | 600 | none | 25 | — | 21 | none | — | — | Comparison |
| 403 | 0.1 | 600 | heated | 30 | 30 | 21 | none | — | — | Invention |
| 404 | 0.1 | 600 | heated | 60 | 30 | 21 | none | — | — | Invention |
| 405 | 0.1 | 600 | heated | 100 | 30 | 21 | none | — | — | Invention |
| 406 | 0.1 | 600 | heated | 100 | 30 | 0.1 | heated | 30 | 30 | Invention |
| 407 | 0.1 | 600 | heated | 100 | 30 | 0.1 | heated | 60 | 30 | Invention |
| 408 | 0.1 | 600 | heated | 100 | 30 | 0.1 | heated | 100 | 30 | Invention |
| 409 | 21 | 600 | heated | 100 | 30 | 0.1 | heated | 100 | 30 | Comparison |
| 410 | 21 | 600 | heated | 100 | 30 | 21 | heated | 100 | 30 | Comparison |
| 411 | 0.1 | 300 | heated | 100 | 30 | 0.1 | heated | 100 | 30 | Invention |
| 412 | 0.1 | 300 | heated | 100 | 30 | 0.1 | none | — | — | Invention |

These samples were evaluated in the same manner as in Example 1. The results are shown in Table 6.

TABLE 6

| | | Pencil | Steel Wool | |
|---|---|---|---|---|
| Sample No. | Reflectance (%) | Hardness | Resistance | Remarks |
| 401 | 1.5 | 2H to 3H | Δ | Invention |
| 402 | 1.5 | 2H | XX | Comparison |
| 403 | 1.5 | 2H to 3H | Δ | Invention |
| 404 | 1.5 | 2H to 3H | Δ to ◯ | Invention |
| 405 | 1.5 | 3H | ◯ | Invention |
| 406 | 1.5 | 3H | ⊚ | Invention |
| 407 | 1.5 | 3H | ⊚ | Invention |
| 408 | 1.5 | 3H | ⊚ | Invention |
| 409 | 1.5 | 2H | X | Comparison |
| 410 | 1.5 | 2H | X | Comparison |
| 411 | 1.5 | 3H | ◯ to ⊚ | Invention |
| 412 | 1.5 | 2H to 3H | ◯ | Invention |

### Example 5

Samples 413 to 418 were produced with the only exception of passing the film through nitrogen-purged zone before the ultraviolet irradiation zone in the production methods of Samples 401, 403, 404, 405, 408 and 409 of Example 4, and evaluated in the same manner. Samples 419 and 420 were produced with the only exception of passing the film through a nitrogen-substituted zone before the ultraviolet irradiation zone in the production method of Sample 405 of Example 3.

TABLE 7

| | Conditions of | | | | | | | |
|---|---|---|---|---|---|---|---|---|
| | Nitrogen-Purged Zone Before | | | | | | | |
| | Ultraviolet Irradiation | | Ultraviolet Irradiation Conditions | | | | | |
| | Oxygen | | Oxygen | | Presence or | Film | Heating | |
| Sample | Concentration | Time Spent | Concentration | Irradiation Dose | Absence of | Temperature | Time | |
| No. | (vol %) | Passing (sec.) | (vol %) | (mJ/cm²) | Heating | (° C.) | (sec.) | Remarks |
| 402 | — | — | 21 | 600 | none | 25 | — | Comparison |
| 403 | — | — | 0.1 | 600 | heated | 30 | 30 | Invention |
| 404 | — | — | 0.1 | 600 | heated | 60 | 30 | Invention |
| 405 | — | — | 0.1 | 600 | heated | 100 | 30 | Invention |
| 408 | — | — | 0.1 | 600 | heated | 100 | 30 | Invention |
| 409 | — | — | 21 | 600 | heated | 100 | 30 | Comparison |
| 413 | 0.1 | 1 | 21 | 600 | none | 25 | — | Comparison |
| 414 | 0.1 | 1 | 0.1 | 600 | heated | 30 | 30 | Invention |
| 415 | 0.1 | 1 | 0.1 | 600 | heated | 60 | 30 | Invention |
| 416 | 0.1 | 1 | 0.1 | 600 | heated | 100 | 30 | Invention |
| 417 | 0.1 | 1 | 0.1 | 600 | heated | 100 | 30 | Invention |
| 418 | 0.1 | 1 | 21 | 600 | heated | 100 | 30 | Comparison |
| 419 | 10 | 1 | 0.1 | 600 | heated | 100 | 30 | Invention |
| 420 | 15 | 1 | 0.1 | 600 | heated | 100 | 30 | Invention |

The results are shown in Table 8. By virtue of passing the film through a nitrogen-purged zone with a low oxygen concentration before the ultraviolet irradiation, enhancement of the scratch resistance is obtained. By the combination with the step of passing the film through a heated nitrogen-purged zone with a low oxygen concentration after the ultraviolet irradiation, the curing becomes prominent.

TABLE 8

| | | Pencil | Steel Wool | |
|---|---|---|---|---|
| Sample No. | Reflectance (%) | Hardness | Resistance | Remarks |
| 402 | 1.5 | 2H | XX | Comparison |
| 403 | 1.5 | 2H to 3H | Δ | Invention |
| 404 | 1.5 | 2H to 3H | Δ to ◯ | Invention |
| 405 | 1.5 | 3H | ◯ | Invention |
| 408 | 1.5 | 3H | ⊚ | Invention |
| 409 | 1.5 | 2H | X | Comparison |
| 413 | 1.5 | 3H | X to Δ | Comparison |
| 414 | 1.5 | 3H | ⊚ | Invention |
| 415 | 1.5 | 3H | ⊚ | Invention |
| 416 | 1.5 | 4H | ⊚ | Invention |
| 417 | 1.5 | 4H | ⊚ | Invention |
| 418 | 1.5 | 2H to 3H | ◯ | Comparison |
| 419 | 1.5 | 4H | ◯ to ⊚ | Invention |
| 420 | 1.5 | 4H | ◯ to ⊚ | Invention |

### Example 6

Antireflection films were produced by changing the coating solution for low refractive index layer in Examples 1 to 5 to the following Coating Solution A or B for Low Refractive Index Layer and evaluated, as a result, the same effects of the present invention were confirmed.

By virtue of using a hollow silica fine particle, a low-reflectance antireflection film having more excellent scratch resistance can be produced.

(Preparation of Sol Solution a)

In a reactor equipped with a stirrer and a reflux condenser, 120 parts of methyl ethyl ketone, 100 parts of acryloyloxypropyltrimethoxysilane (KBM-5103, produced by Shin-Etsu Chemical Co., Ltd.) and 3 parts of diisopropoxyaluminum ethyl acetoacetate (KEROPE EP-12, trade name, produced by Hope Chemical Co., Ltd.) were added and mixed and after adding thereto 30 parts of ion-exchanged water, the reaction was allowed to proceed at 60° C. for 4 hours. Thereafter, the reaction product was cooled to room temperature to obtain Sol Solution a. The mass average molecular weight was 1,600 and out of the oligomer or greater polymer components, the component having a molecular weight of 1,000 to 20,000 occupied 100%. Also, the gas chromatography revealed that the raw material acryloyloxypropyltrimethoxysilane was not remaining at all.

(Preparation of Hollow Silica Fine Particle Liquid Dispersion)

To 500 parts of a hollow silica fine particle sol (isopropyl alcohol silica sol, CS60-IPA, produced by Catalysts & Chemicals Ind., Co., Ltd., average particle diameter: 60 nm, shell thickness: 10 nm, silica concentration: 20%, refractive index of silica particle: 1.31), 30 parts of acryloyloxypropyltrimethoxysilane (KBM-5103, produced by Shin-Etsu Chemical Co., Ltd.) and 1.5 parts of diisopropoxyaluminum ethyl acetate (KEROPE EP-12, trade name, produced by Hope Chemical Co., Ltd.) were added and mixed, and 9 parts of ion-exchanged water was further added. After allowing the reaction to proceed at 60° C. for 8 hours, the reaction product was cooled to room temperature, and 1.8 parts of acetylacetone was added thereto to obtain a hollow silica liquid dispersion. The solid content concentration of the obtained hollow silica liquid dispersion was 18 mass %, and the refractive index after the drying of solvent was 1.31.

(Preparation of Coating Solution A for Low Refractive Index Layer)

Composition of Coating Solution A for Low Refractive Index Layer

| | |
|---|---|
| DPHA | 3.3 g |
| Hollow silica fine particle liquid dispersion | 40.0 g |
| RMS-033 | 0.7 g |
| IRGACURE OXE01 | 0.2 g |
| Sol Solution a | 6.2 g |
| Methyl ethyl ketone | 290.6 g |
| Cyclohexanone | 9.0 g |

(Preparation of Coating Solution B for Low Refractive Index Layer)

Composition of Coating Solution B for Low Refractive Index Layer

| | |
|---|---|
| DPHA | 1.4 g |
| Copolymer P-3 | 5.6 g |
| Hollow silica fine particle liquid dispersion | 20.0 g |
| RMS-033 | 0.7 g |
| IRGACURE OXE01 | 0.2 g |
| Sol Solution a | 6.2 g |
| Methyl ethyl ketone | 306.9 g |
| Cyclohexanone | 9.0 g |

The compounds used are as follows. KBM-5103:

a silane coupling agent (produced by Shin-Etsu Chemical Co., Ltd.) DPHA:

a mixture of dipentaerythritol pentaacrylate and dipentaerythritol hexaacrylate (produced by Nippon Kayaku Co., Ltd.) RMS-033:

a reactive silicone (produced by Gelest) IRGACURE OXE01:

a photopolymerization initiator (produced by Ciba Specialty Chemicals)

### Example 7

Antireflection films were produced by changing the coating solution for low refractive index layer in Examples 1 to 5 to the following Coating Solution C for Low Refractive Index Layer and evaluated, as a result, the same effects of the present invention were confirmed. Also, even when OPSTAR JN7228A in the low refractive index layer was changed by an equivalent mass of JTA 113 enhanced in the crosslinking degree (produced by JSR Corp.), the same effects were obtained.

(Preparation of Coating Solution C for Low Refractive Index Layer)

The following composition was charged into a mixing tank and stirred, and the resulting solution was filtered through a polypropylene-made filter having a pore size of 1 m to prepare Coating Solution C for Low Refractive Index Layer.

Composition of Coating Solution C for Low Refractive Index Layer

| | |
|---|---|
| OPSTAR JN7228A (liquid composition of a thermal | 100 parts by mass |
| crosslinking fluorine-containing polymer containing | |
| a polysiloxane and a hydroxyl group, produced by | |
| JSR Corp.) | |
| MEK-ST (silica dispersion, average particle | 4.3 parts by mass |
| diameter: 15 nm, produced by Nissan | |
| Chemicals Industries, Ltd.) | |
| A product differing in the particle diameter from | 5.1 parts by mass |
| MEK-ST (silica dispersion, average particle | |
| diameter: 45 nm, produced by Nissan Chemicals | |
| Industries, Ltd. | |
| Sol Solution a | 2.2 parts by mass |
| MEK | 15 parts by mass |
| Cyclohexanone | 3.6 parts by mass |

The coating solution for low refractive index layer prepared above was coated by using a doctor blade and a microgravure roll having a diameter of 50 mm and having a gravure pattern with a line number of 200 lines/inch and a depth of 30 μm under the condition of a transportation speed of 10 m/min and after drying at 120° C. for 150 seconds and further at 140° C. for 12 minutes, irradiated with an ultraviolet ray described in Example 1 to produce samples. The rotation number of the gravure roll was adjusted to give a low refractive index layer thickness of 100 nm after curing.

### Example 8

(Production of Protective Film for Polarizing Plate)

An aqueous 1.5 mol/liter sodium hydroxide solution was kept at 50° C. to prepare a saponification solution. Separately, an aqueous 0.005 mol/liter dilute sulfuric acid solution was prepared. In the antireflection films produced in Examples 1 to 7, the surface of the transparent substrate on the side opposite the surface having the cured layer of the present invention was treated by saponification with the saponification solution prepared above.

The transparent substrate surface treated by saponification was washed with water to thoroughly rinse away the aqueous sodium hydroxide solution, washed with the aqueous dilute sulfuric acid solution prepared above, further washed with water to thoroughly rinse away the aqueous dilute sulfuric acid solution, and then thoroughly dried at 100° C.

The contact angle with water of the transparent substrate surface treated by saponification on the side opposite the surface having the cured layer of the antireflection film was evaluated and found to be 40° or less. In this way, a protective film for a polarizing plate was produced.

### Example 9

(Production of Polarizing Plate)

A 75 μm-thick polyvinyl alcohol film (produced by Kuraray Co., Ltd.) was dipped in an aqueous solution containing 1,000 parts by mass of water, 7 parts by mass of iodine and 105 parts by mass of potassium iodide for 5 minutes to adsorb iodine.

Subsequently, this film was uniaxially stretched to 4.4 times in the longitudinal direction in an aqueous 4 mass % boric acid solution and while in the state of tension, dried to produce a polarizing film.

One surface of the polarizing film was laminated with the saponified triacetyl cellulose surface of the antireflection film (protective film for a polarizing plate) produced in Examples 1 to 7 and saponified in Example 8 by using a polyvinyl alcohol-based adhesive as the adhesive. Furthermore, by using the same polyvinyl alcohol-based adhesive, another surface of the polarizing film was laminated with a triacetyl cellulose film treated by saponification in the same manner as above.

(Evaluation of Image Display Device)

The transmissive, reflective or transflective liquid crystal display device in a mode of TN, STN, IPS, VA or OCB, where the polarizing plate of the present invention produced above was loaded to come as the outermost surface of the display, was excellent in the antireflection performance and remarkably excellent in the visibility. In particular, the effects are prominent in the VA mode.

### Example 10

(Production of Polarizing Plate)

The surface of an optical compensation film (Wide View Film SA 12B, produced by Fuji Photo Film Co., Ltd.) on the side opposite the surface having an optical compensation layer was treated by saponification under the same conditions as in Example 8. One surface of the polarizing film produced in Example 9 was laminated with the saponified triacetyl cellulose surface of the antireflection film (protective film for a polarizing plate) produced in Examples 1 to 7 and saponified in Example 8 by using a polyvinyl alcohol-based adhesive as the adhesive. Furthermore, by using the same polyvinyl alcohol-based adhesive, another surface of the polarizing film was laminated with the triacetyl cellulose surface of the optical compensation film treated by saponification.

(Evaluation of Image Display Device)

The transmissive, reflective or transflective liquid crystal display device in a mode of TN, STN, IPS, VA or OCB, where the polarizing plate of the present invention produced above was loaded to come as the outermost surface of the display, was excellent in the bright room contrast as compared with a liquid crystal display device having loaded therein a polarizing plate not using an optical compensation film, and assured of very wide viewing angle in the up/down and right/left directions, excellent antireflection performance and remarkably high visibility and display grade.

In particular, the effects are prominent in the VA mode.

1. A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) and (2):
(1) a step of applying a coating layer on a transparent substrate, and
(2) a step of curing said coating layer by irradiating ionizing radiation in an atmosphere having an oxygen concentration lower than the oxygen concentration in the air.

2. A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) to (3), with the transportation step of (2) and the curing step of (3) being continuously performed:
(1) a step of applying a coating layer on a transparent substrate,
(2) a step of transporting said film having the coating layer in an atmosphere having an oxygen concentration lower than the oxygen concentration in the air, and
(3) a step of curing the coating layer by irradiating ionizing radiation on said film in an atmosphere having an oxygen concentration of 3 vol % or less.

3. A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) to (3), with the transportation step of (2) and the curing step of (3) being continuously performed:
(1) a step of applying a coating layer on a transparent substrate,
(2) a step of transporting said film having the coating layer in an atmosphere having an oxygen concentration lower than the oxygen concentration in the air, and
(3) a step of curing the coating layer by irradiating ionizing radiation on said film in an atmosphere having an oxygen concentration of 3 vol % or less while heating the film to give a film surface temperature of 25° C. or more.

4. A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) to (3), with the transportation step of (2) and the curing step of (3) being continuously performed:
(1) a step of applying a coating layer on a transparent substrate,
(2) a step of transporting said film having the coating layer in an atmosphere having an oxygen concentration lower than the oxygen concentration in the air while heating the film to give a film surface temperature of 25° C or more, and
(3) a step of curing the coating layer by irradiating ionizing radiation on said film in an atmosphere having an oxygen concentration of 3 vol % or less.

5. A method for producing an antireflection film comprising: a transparent substrate; an antireflection layer comprising at least one layer, the antireflection layer being on the transparent substrate,
the production method comprising:
forming at least one layer of layer(s) stacked on the transparent support, by a layer forming method comprising the following steps (1) to (3), with the transportation step of (2) and the curing step of (3) being continuously performed:
(1) a step of applying a coating layer on a transparent substrate,
(2) a step of transporting said film having the coating layer in an atmosphere having an oxygen concentration lower than the oxygen concentration in the air while heating the film to give a film surface temperature of 25° C. or more, and
(3) a step of curing the coating layer by irradiating ionizing radiation on said film in an atmosphere having an oxygen concentration of 3 vol % or less while heating the film to give a film surface temperature of 25° C. or more.

6. The method for producing an antireflection film comprising: a transparent substrate; an antireflection layer comprising at least one layer, the antireflection layer on the transparent substrate,
wherein the layer forming method as claimed in any one of claims 1 to 5, comprises, in succession to the curing step of the coating layer by the irradiation with ionizing radiation, a step of transporting said cured film in an atmosphere having an oxygen concentration of 3 vol % or less while heating the film to give a film surface temperature of 25° C. or more.

7. The method for producing an antireflection film,
wherein said antireflection film comprises a low refractive index layer having a thickness of 200 nm or less and said low refractive index layer is formed by the layer forming method as claimed in any of claims 1 to 5.

8. The method for producing an antireflection film as claimed in any one of claims 1 to 5,
wherein said ionizing radiation is an ultraviolet ray.

9. The method for producing an antireflection film as claimed in any one of claims 3 to 5,
wherein the heating during and/or before said irradiation with ionizing radiation and/or the heating after the irradiation with ionizing radiation is performed to give a film surface temperature of 25 to 170° C.

10. The method for producing an antireflection film as claimed in any one of claims 3 to 5,
wherein the heating during and/or before said irradiation with ionizing radiation and/or the heating after the irradiation with ionizing radiation is performed by contacting the film with a heated roll.

11. The method for producing an antireflection film as claimed in any one of claims 3 to 5,
wherein the heating during and/or before said irradiation with ionizing radiation and/or the heating after the irradiation with ionizing radiation is performed by blowing a heated nitrogen gas.

12. The method for producing an antireflection film as claimed in any one of claims 1 to 5,
wherein said transportation step and/or said curing step by the irradiation with ionizing radiation each is performed in a low oxygen concentration zone displaced with nitrogen, and
the nitrogen in the zone for performing the curing step by the irradiation with ionizing radiation is discharged to the zone for performing the previous step and/or the zone for performing the subsequent step.

13. An antireflection film produced by the method claimed in any one of claims 1 to 5.

14. The antireflection film as claimed in claim 13, wherein said low refractive index layer is formed by a coating solution comprising a fluorine-containing polymer represented by the following formula 1: Formula 1: 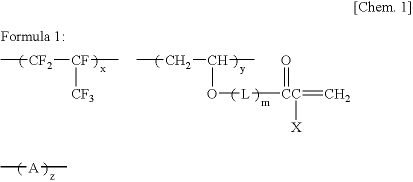
wherein L represents a linking group having a carbon number of 1 to 10, m represents 0 or 1, X represents a hydrogen atom or a methyl group, A represents a polymerization unit of an arbitrary monomer and may comprise a single component or a plurality of components, and x, y and z represent mol % of respective constituent components and each represents a value satisfying 30≦x≦60, 5≦y≦70 and 0≦z≦65.

15. The antireflection film as claimed in claim 13,
wherein said low refractive index layer comprises a hollow silica fine particle.

16. A polarizing plate comprising the antireflection film claimed in claim 13 as at least either one protective film of two protective films in the polarizing plate.

17. An image display device comprising the anti-reflection film claimed in claim 13 or the polarizing plate claimed in claim 16 on the outermost surface of the display.

18. An image display device comprising the polarizing plate claimed in claim 16 on the outermost surface of the display.
